(19) United States
(12) Patent Application Publication
(10) Pub. No.: US 2013/0180671 A1
(43) Pub. Date: Jul. 18, 2013

(54) WINDOW BLIND ASSEMBLIES

(71) Applicant: Ward Adhesives Holding Company, Pewaukee, WI (US)

(72) Inventors: Doug Deitz, Vadnais Heights, MN (US); Thomas H. Quinn, St. Paul, MN (US)

(73) Assignee: WARD ADHESIVES HOLDING COMPANY, Pewaukee, WI (US)

(21) Appl. No.: 13/742,503

(22) Filed: Jan. 16, 2013

Related U.S. Application Data
(60) Provisional application No. 61/587,034, filed on Jan. 16, 2012.

(51) Int. Cl. E06B 9/24; B32B 37/12

(52) U.S. Cl. CPC E06B 9/24; B32B 37/12
USPC 160/84.05; 156/327

(57) ABSTRACT

Disclosed herein are cellular blind constructions including a plurality of tubular cellular elements and a thermoplastic hot melt adhesive composition disposed between tubular cellular elements. The thermoplastic hot melt adhesive composition includes a metallocene-polymerized propylene copolymer and a functionalized polyolefin including groups derived from maleic anhydride or acrylic acid and is characterized by the absence of tackifiers, plasticizers, and waxes. The thermoplastic hot melt adhesive composition is thermally stable and UV resistant under the environmental conditions encountered by the cellular blind constructions.

### BACKGROUND OF THE INVENTION

Thermal insulating blinds or shades having a cellular structure are useful as an energy efficient and attractive alternative to other window coverings such as rollup window shades, traditional Venetian blinds, and shutters. Cellular blinds, also called honeycomb blinds, are also aesthetically desirable coverings for windows, glass doors, and the like. An example of cellular fashion blinds are those manufactured and sold under the trademark DUETTE® by Hunter Douglas Corporation of Upper Saddle River, N.J. Such cellular blind structures have applications in a wide variety of market segments. As cellular window and door blind structures have grown in popularity, there is an ongoing need for more efficient and cost effective methods of manufacturing the cellular structures and cellular blind assemblies.

Cellular blinds are exposed to harsh environmental conditions, including heat and UV radiation, when situated in an end-use window application. As is mentioned above, cellular blinds are energy efficient when compared to more traditional window coverings; this is due to the cellular construction of the blind wherein a side view of the blind reveals a tubular shape. The tubular shape provides insulation properties by creating air pockets. The materials employed in the construction of cellular must be sufficiently heat and UV resistant that, at the temperatures actually encountered within the insulated blind construction, the blind is not quickly deteriorated. The blind construction and materials must be robust enough to withstand direct sunlight and/or temperatures of 70° C. or higher repeatedly for several hours each day.

Some methods of manufacturing cellular blinds employ hot melt adhesive compositions. Hot melt adhesive compositions are formulations that include one or more structural or base polymers and one or more adjuvants. Adjuvants typically include functional materials or diluents such as tackifying resins, plasticizers, fillers, oils, waxes, or other low molecular weight polymers. The base polymer is typically the major component of a hot melt adhesive formulation and contributes cohesive strength to the adhesive. The hot melt adhesive composition is typically loaded onto a manufacturing line in a molten state inside a holding tank, and is applied between cellular blind elements by applying at least one bead, dot, or line, of molten adhesive to the tubular elements that are stacked together to form the blind, followed by stacking another tubular element atop the adhesive bead to form an adhesive bond therebetween. In some cases, the tubular elements are also formed from flat substrates by folding the substrate into a tubular shape and affixing the ends of the substrate with the hot melt adhesive. Hot melt adhesives that find utility in cellular blind construction are those that do not soften or leach low molecular weight components out of the adhesive area at the extreme temperature ranges sometimes encountered in end-use applications. Additionally, the adhesive must be UV resistant such that it does not harden, crack, or discolor after prolonged exposure to direct sunlight.

A representative process for fabricating and assembling cellular blind elements using hot melt adhesives is disclosed by Schnebly, U.S. Pat. No. 4,732,630. The process includes folding a continuous length of material along opposite side portions thereof into a generally flattened, tubular form having upper and lower layers. Adhesive is applied along the length of the continuous material by first heating the material, applying the adhesive in a liquid state to the heated material, and then cooling the material to solidify the adhesive. The folded tubular material with solidified adhesive lines thereon is then wound about a rack in such a manner that the tubular material is deposited in a plurality of continuous layers one on another the lines of adhesive being disposed between adjacent layers. The continuous wound layers are then radially cut and placed in a vertical stack as they are removed from the rack. The vertically stacked layers are then heated to a temperature sufficient to “activate” the lines of adhesive and bond the stacked layers together. Finally, the stacked tubular material is cooled to form a unitary stack of tubular, expandable cellular material. FIGS. 12 and 13 of Schnebly are instructive as to the methods employed. Other cellular blind construction methodologies are described elsewhere, wherein hot melt adhesives are employed. In all such cases, the adhesive is employed in a narrow bead lengthwise along the tubular blind elements. The narrow bead can be applied in the melt or can be applied, for example, as a formed yarn or nonwoven material that is later melted to provide the adhesion.

Conventional hot melt adhesives that have enjoyed utility in window blind constructions are copolyester based adhesives and polyurethane adhesives. In such constructions, the hot melt adhesives employed are curable in order to impart sufficient heat resistance to withstand the challenging environment encountered in window blind applications. Curable adhesives can be activated and cured by thermal, UV, or other means of crosslinking after the initial extrusion and solidification, in order to build in thermal stabilization against remelt and softening. However, such crosslinking necessitates an extra step in the manufacturing process.

Curable copolyester based hot melt adhesives are one example of a post-cured hot melt adhesive used in window blind constructions. Examples of window blind constructions that employ copolyester hot melt adhesives include U.S. Pat. Nos. 6,497,266, 6,302,982, 6164363, 5490553, and 5390720. However, copolyester hot melt adhesives having sufficient adhesive and cohesive strength along with high temperature performance for cellular blind constructions have very high viscosity in the melt. In order for such adhesives to be applied by conventional equipment, temperatures of about 200° C.-230° C. (about 400° F.-450° F.) are employed. At such high temperatures the storage of adhesive in the molten state, which is the preferred means of preparing and maintaining the adhesive for application on a production line, is problematic because degradation of polymer chains will happen relatively quickly. Thus, throughput and volume of molten adhesive must be carefully controlled to avoid excessive waste or down time on the manufacturing line. To avoid such issues, as well as to reduce energy use, and further to reduce wear and tear on the adhesive application equipment, it is desirable to apply hot melt adhesives at lower temperature ranges. For example, it is desirable to apply hot melt adhesives at temperatures of about 175° C.-200° C. (350° F.-400° F.).

In other constructions, the curable adhesive is supplied in two parts, and a crosslinking reaction is initiated by mixing the two parts just before application. While this approach can circumvent the high temperature application issues provided by the polyester based adhesives, the two-part application presents an inconvenience in that a set amount of time between mixing and application of the adhesive must be maintained. This in turn constrains manufacturing operations and potentially creates waste either by wasting adhesive when the manufacturing line is held up, or dispensing before or after the ideal time, leading to weak and/or inconsistent construction strength in the finished article. Some representative examples of curable hot melt adhesives employed in window blind constructions are described in U.S. Patent Publication Nos. 20070187051 and 20100065228 and in U.S. Pat. Nos. 7,980,288, 6,302,982, 5390720, and 4732630. Polyurethane two-part hot melt adhesives are one example of a curable hot melt adhesive commonly employed in window blind constructions. Polyurethanes are well known to be susceptible to UV yellowing and eventually become brittle and may crack. In some cases, sufficient UV stabilizing compounds can be added to a curable polyurethane hot melt adhesive composition to overcome this inherent weakness for a period of time.

Thus, while conventional adhesives such as curable polyesters and two-part curable urethanes have sufficient heat resistance to withstand temperatures encountered by cellular blinds in use, there are significant issues encountered by the manufacturer in the use of these adhesives.

### SUMMARY OF THE INVENTION

A first aspect of the invention is a cellular blind construction including
a. a plurality of cellular elements, each element having an outer surface, and a length, the outer surface including a first element contact area and a second element contact area, the element contact areas traversing the length of the cellular elements; and
b. an effective amount of a hot melt adhesive composition disposed between the cellular elements to adhere the elements to each other at their respective first and second element contact areas, the hot melt adhesive composition including:
   i. a copolymer of propylene and at least one comonomer selected from the group consisting of ethylene and C₄ to C₂₀ α-olefins, wherein the copolymer has a propylene content of greater than 65 mole %, a Brookfield viscosity at 190° C. of about 200 cP to 25,000 cP, and a density of about 0.860 g/cm³ to 0.868 g/cm³; and
   ii. about 0.1 wt % to 10 wt % of a functionalized polyolefin comprising groups derived from maleic anhydride or acrylic acid.
      In some embodiments, the hot melt adhesive is also used to form the cellular elements. In such embodiments, a cellular element includes
a. a substrate having a length, a width, a first lengthwise edge, a second lengthwise edge, and a first major surface including a first contact area and a second contact area, and a second major surface, wherein the first contact area spans the length proximal to the first lengthwise edge and the second contact area spans the length proximal to the second lengthwise edge; and
b. an effective amount of a hot melt adhesive composition disposed between the first and second contact areas and adhering the first and second contact areas, the hot melt adhesive composition including
   i. a copolymer of propylene and at least one comonomer selected from the group consisting of ethylene and C₄ to C₂₀ α-olefins, wherein the copolymer has a propylene content of greater than 65 mole %, a Brookfield viscosity at 190° C. of about 200 cP to 25,000 cP, and a density of about 0.860 g/cm³ to 0.868 g/cm³; and
   ii. about 0.1 wt % to 10 wt % of a functionalized polyolefin comprising groups derived from maleic anhydride or acrylic acid;
wherein the width of the substrate between the first and second contact areas defines the diameter of the cellular element, the length of the substrate defines the length of the cellular element, and the second major surface of the substrate defines the outer surface of the tubular element.
   A second aspect of the invention is a double-cell blind construction including
a. a pleated substrate attached between pleats in a double-cell configuration, and
b. a hot melt adhesive composition disposed between the pleats to attach the pleats in the double-cell configuration, the hot melt adhesive composition including:
   i. a copolymer of propylene and at least one comonomer selected from the group consisting of ethylene and C₄ to C₂₀ α-olefins, wherein the copolymer has a propylene content of greater than 65 mole %, a Brookfield viscosity at 190° C. of about 200 cP to 25,000 cP, and a density of about 0.860 g/cm³ to 0.868 g/cm³; and
   ii. about 0.1 wt % to 10 wt % of a functionalized polyolefin comprising groups derived from maleic anhydride or acrylic acid.

In some embodiments, the cellular or double-cell blind constructions (collectively, the blinds, the blind constructions, or the blind assemblies) further include one or more additional items including a bottom rail, a top panel, and one or more lift cords, fabric tapes, decorative items, and the like. In embodiments the blinds are intended for use with an architectural opening, such as a window or a door. In any of the embodiments described herein, the hot melt adhesive compositions are characterized by the absence of tackifiers, plasticizers, and waxes. In some embodiments, the hot melt adhesive compositions include materials in addition to the polypropylene copolymers and the functionalized polyolefin. For example, in some embodiments, the adhesive compositions include one or more nucleating agents that cause a significant decrease in the effective set time of the adhesives. Where employed, the nucleating agents are also metallocene polyolefin based. In other embodiments a longer set time is desirable and so no additional nucleating agents are included in the adhesive compositions. In some embodiments, the adhesive compositions further include one or more additional polymers. In some embodiments, the adhesive compositions include one or more UV stabilizers or antioxidants. In some embodiments, the adhesive compositions include a combination of two or more such additional materials, or combinations thereof.

The adhesive compositions have a short set time, which is critical for the manufacturing process, and an open time that is optimal for the blind manufacturing process and prevents the adhesive from bleeding through e.g. nonwoven fabrics. When in place in one or more end use applications, the blinds of the invention withstand direct sunlight and/or temperatures of 70° C. or higher without appreciable flow or loss of adhesive or cohesive strength. Upon such exposure, the adhesives do not substantially soften, flow, yellow, crack, or leach components thereof into or onto the cellular blind elements. This in turn provides for a robust, stable construction even under the harshest environmental conditions encountered. The excellent adhesive and cohesive strength of the adhesives is useful in conjunction with a wide variety of blind substrates, including both fabrics and non-fabric sheet substrates.

The hot melt adhesive compositions employed in the blind constructions of the invention have excellent rheological properties in the melt, enabling their application by conventional hot melt adhesive application equipment at ideal hot melt adhesive application temperatures. The hot melt adhesive compositions are stable for long periods in the molten state, allowing for breadth of construction conditions, timing of application, and size of the molten adhesive reservoir that can be used in manufacture. The hot melt adhesive compositions provide excellent adhesive performance for a wide range of woven, knit, and nonwoven fabrics as well as flat sheet materials employed in blind elements. The hot melt adhesives are not crosslinked; yet the heat resistance thereof is suitable for the application because of the high, sharp melting point of the composition. Stated differently, the adhesive composition does not undergo softening at temperatures substantially below the melt/flow point as is the cases with conventional hot melt adhesives. Further, the UV resistance of the adhesive compositions is good due to the absence of aromatic compounds or other UV reactive moieties or color bodies in the major components of the composition. In some embodiments, it is desirable to add additional UV stabilizing compounds to the adhesive compositions. The hot melt adhesives are characterized by the absence of tackifiers, plasticizers, and waxes. This in turn gives rise to additional thermal and UV stability and obviates concerns about leachable, flowable compounds in the cellular blind constructions of the invention.

The thermal stability of the adhesives enables the use of black, brown, gray, navy blue, or other dark colors in the blinds that otherwise, when exposed to direct sunlight, would cause the blind—and therefore the adhesive—to heat to the point where it would soften, flow, yellow, crack, or leach plasticizers or waxes from the adhesive application areas in the presence of conventional adhesives. Further, the thermal and UV stability of the adhesives enables the use of cellular blinds in applications where such blinds, constructed using conventional hot melt adhesives, could not previously be used due to harsh conditions where heat and/or UV exposure is greater than that of standard window and door type applications. Two such applications are boat coverings and boat awnings: boat coverings are often exposed to direct sunlight while disposed at or near horizontal angles, and serve to cover an insulated cabin that can reach very high temperatures while sitting in direct sunlight. Awnings, like boat covers, are exposed to direct sunlight while in some cases disposed at or near horizontal angles.

The hot melt adhesive compositions are highly advantageous additionally due to their low density compared to conventional hot melt adhesive formulations typically employed in window blind manufacturing. This enables a lower weight of adhesive to be used in making each bond without using a smaller volume of adhesive in order to decrease the weight of adhesive applied. In embodiments where one bead of adhesive (that is, a strip of adhesive applied lengthwise across the blind) is employed per cell in a cellular blind assembly, the weight of multiple beads of adhesive—which can number between 1 and 1000—collectively affect the overall construction. The weight of the lower cells applies a load to the upper cell bonds; where this weight is decreased, the advantage of lowering the load applied to the upper cell bonds is a more stable and robust cellular blind assembly and a lighter blind weight overall, without compromising bond strength. In the instant invention, the hot melt adhesive compositions employed have a density of less than 1 g/cm³, for example as low as 0.860 g/cm³, because the polypropylene base copolymers have a density of about 0.860 g/cm³ to 0.868 g/cm³. In contrast, conventional polyester-based adhesives have densities well in excess of 1 g/cm³, for example 1.2 g/cm³ or more.

A third aspect of the invention is a method of making a cellular blind assembly, the method including the steps of
a) applying a first effective amount of a molten hot melt adhesive composition to a first contact area of a first major surface of a substrate, the hot melt adhesive composition including
   i. at least one polypropylene copolymer having one or more comonomers selected from the group including ethylene and a C₄ to C₂₀ α-olefin, and
   ii. at least one functionalized polyolefin comprising groups derived from maleic anhydride or acrylic acid;
b) contacting the first element contact area to a second element contact area to form a first cellular blind element;
c) applying a second effective amount of the molten hot melt adhesive composition to a first element contact area of the first cellular blind element;
d) contacting the first element contact area of the first cellular element to a second contact area of a second cellular element; and
e) repeating steps a) to d) from 1 to 1000 times to form a cellular blind assembly.

Steps a) and b) are carried out, in various embodiments, contemporaneously with or subsequent to steps c) and d). In some embodiments, the substrate is pleated. In some embodiments, the substrate has differently colored portions on at least the one major surface thereof, such that the color on a first side of the assembled blind is a first color and the color of a second side of the assembled blind is a second color. In some embodiments, the method further includes collapsing the assembled blind into a stack for storage or further assembly. In some embodiments one or more additional steps carried out include cutting the blind assembly to a selected length, attaching a bottom rail to the blind assembly, attaching an upper panel to the blind assembly, and threading one or more lift cords through the blind assembly and attaching the lift cord to at least the upper panel. In embodiments one or more of the additional steps includes attaching using the hot melt adhesive composition.

A fourth aspect of the invention is a method of making a double-cell blind assembly, the method including the steps of
a) applying a first effective amount of a molten hot melt adhesive composition to a first contact area of a first major surface of a substrate, the hot melt adhesive composition including
   i. at least one polypropylene copolymer having one or more comonomers selected from the group including ethylene and a C₄ to C₂₀ α-olefin, and
   ii. at least one functionalized polyolefin comprising groups derived from maleic anhydride or acrylic acid;
b) contacting the first contact area to a second contact area of the first major surface of the substrate to form a first cellular blind element;
c) applying a second effective amount of the molten hot melt adhesive composition to a third contact area of a second major surface of the substrate;
d) contacting the third contact area to a fourth contact area on the second major surface to form a second cellular blind element; and
e) repeating steps a) to d) from 1 to 1000 times to form a double-cell blind assembly.

Steps a) and b) are carried out, in various embodiments, contemporaneously with or subsequent to steps c) and d). In some embodiments, the substrate is pleated or creased. In some embodiments, the substrate has differently colored portions on at least one major surface thereof, such that the color on a first side of the assembled blind is a first color and the color of a second side of the assembled blind is a second color. In some embodiments, the method further includes collapsing the assembled blind into a stack for storage or further assembly. In some embodiments one or more additional steps include forming a finished window blind by cutting the blind assembly to a selected length, attaching a bottom rail to the blind assembly, attaching an upper panel to the blind assembly, and threading one or more lift cords through the blind assembly and attaching the lift cord to at least the upper panel. In one or more of the additional steps, the attaching employs the hot melt adhesive composition.

The blind assemblies are easy to manufacture because of the ease of use of the hot melt adhesive compositions. The hot melt adhesive compositions are formulated using standard equipment to yield a conventional, one-part blend of ingredients that are applied using standard hot melt application equipment. The adhesive compositions are thermoplastic, so adjustments in positioning during or after assembly of the cellular blind constructions can be accomplished by re-heating the adhesive after application. The adhesive compositions are not covalently crosslinked, so no special equipment or formulating steps are required. In embodiments, the adhesive compositions are stored in the solid or molten state and applied on demand with a tailorable set time and open time. The hot melt adhesive composition has good adhesion to a variety of substrates and thus the cellular blinds can be constructed with a wide variety of fabrics and sheet substrates. The resulting cellular blind constructions are securely adhered and are surprisingly environmentally durable and stable under the conditions to which cellular blinds are subjected. The superior performance of the blinds of the invention gives rise to new potential applications in highly challenging environments where hot melt adhesive based constructions have not previously been possible.

Additional advantages and novel features of the invention will be set forth in part in the description that follows, and in part will become apparent to those skilled in the art upon examination of the following, or may be learned through routine experimentation upon practice of the invention.

### DESCRIPTION OF THE DRAWINGS

FIGS. 1A to 1D are representations of one embodiment of the invention from various perspectives.

FIGS. 2A to 2D are side view representations of blind assemblies of the invention.

FIGS. 3A to 3E are representations of one embodiment of the invention from various perspectives.

FIGS. 4A to 4D are representations of one embodiment of the invention from various perspectives.

### DETAILED DISCUSSION OF THE INVENTION

Various embodiments will now be described in detail. Reference to various embodiments does not limit the scope of the claims attached hereto. Additionally, any examples set forth in this specification are not intended to be limiting and merely set forth some of the many possible embodiments for the appended claims.

### DEFINITIONS

As used herein, the terms “metallocene copolymer”, “polypropylene copolymer”, “propylene copolymer”, or “base copolymer” means a semicrystalline copolymer of propylene and at least one monomer selected from the group including ethylene and a C₄ to C₂₀ α-olefin, wherein the copolymer has a propylene content of greater than 65 mole %, a Brookfield viscosity at 190° C. of about 200 cP to 25,000 cP, and a density of about 0.860 g/cm³ to 0.868 g/cm³.

As used herein, the term “functionalized polyolefin” means a polyethylene, polypropylene, or copolymer thereof further comprising groups derived from maleic anhydride or acrylic acid.

As used herein, the term “set time” means the period of time between application of a hot melt adhesive formulation on a first substrate—followed by addition of a second substrate to be adhered to the first substrate—and the point at which the adhesive bond between the first and second substrates is of sufficient strength for an intended end use. In some embodiments, the first and second substrates are the same substrate, wherein the substrate is folded upon itself and affixed in such a configuration by the hot melt adhesive.

As used herein, the term “open time” means the amount of time elapsed between application of a molten hot melt adhesive composition to a first substrate, and the time when wetting out of the adhesive on a substrate effectively ceases due to solidification of the adhesive composition. Open time is also referred to as “working time.” In some embodiments, the first and second substrates are the same substrate, wherein the substrate is folded upon itself and affixed in such a configuration by the hot melt adhesive.

As used herein, the term “adhesive bead” means a hot melt adhesive, delivered in a molten state through an orifice with a defined dimension so as to deposit a strip, stripe, or section thereof of the adhesive having a dimension substantially defined by the orifice.

As used herein, the term “substrate” means any fabric or sheet, or combination of one or more thereof used in constructing a cellular element. Substrates include woven fabrics, nonwoven fabrics, knit fabrics, fiberglass, and synthetic polymer sheets.

As used herein, the term “cellular element” means a generally a single, tubular shape formed from a suitable fabric, sheet, or combination of one or more thereof. The tubular shapes are of a selected length and circumference based on the size of the window, door, opening, or the like to be covered. In many embodiments, the length of the cellular element is limited, in practicality, either by the width of fabric or other webs available from manufacturers of such materials, or by the ability of the manufacturing equipment to assemble elements longer than a certain length; however, the length of the cellular elements are not otherwise limited. In some embodiments, the length of the cellular element has an upper limit of e.g. 203 cm (80 inches) to 244 cm (96 inches). In some embodiments, the cross-section of a cellular element is a circle, an oval, a square, a rectangle, a football shape, an airfoil (teardrop) shape, an egg shape, or any modified version thereof or of any other shape that is envisioned by one having skill. In some embodiments the cellular element is hollow; in other embodiments the element has a foam, a foil, or a combination thereof disposed within the interior portion of the cellular element in order to increase privacy or thermal insulating ability.

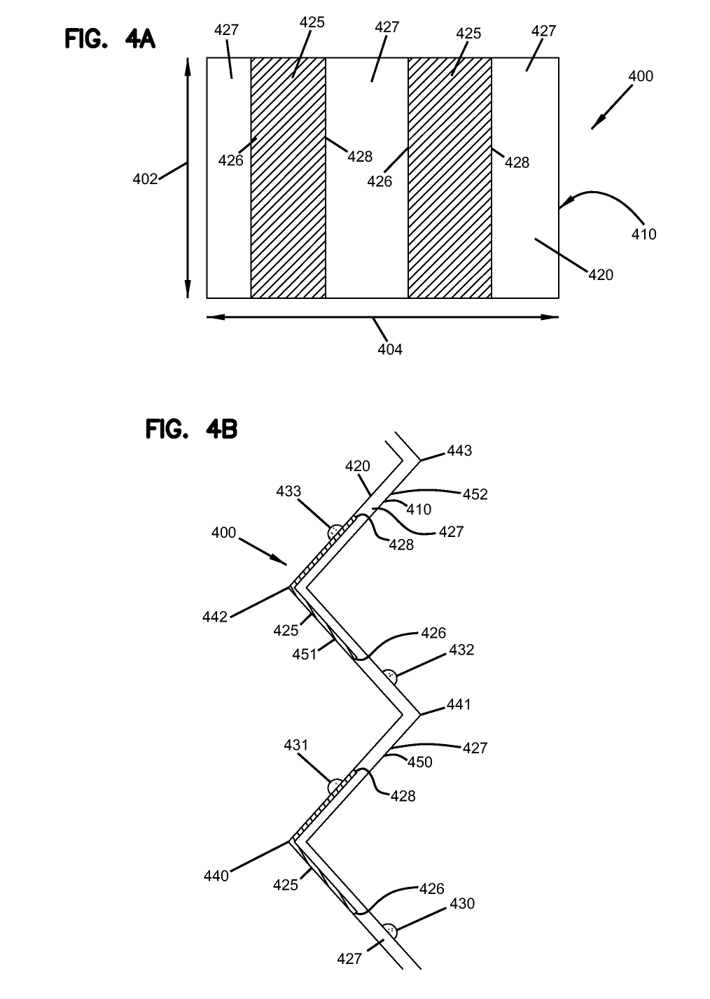

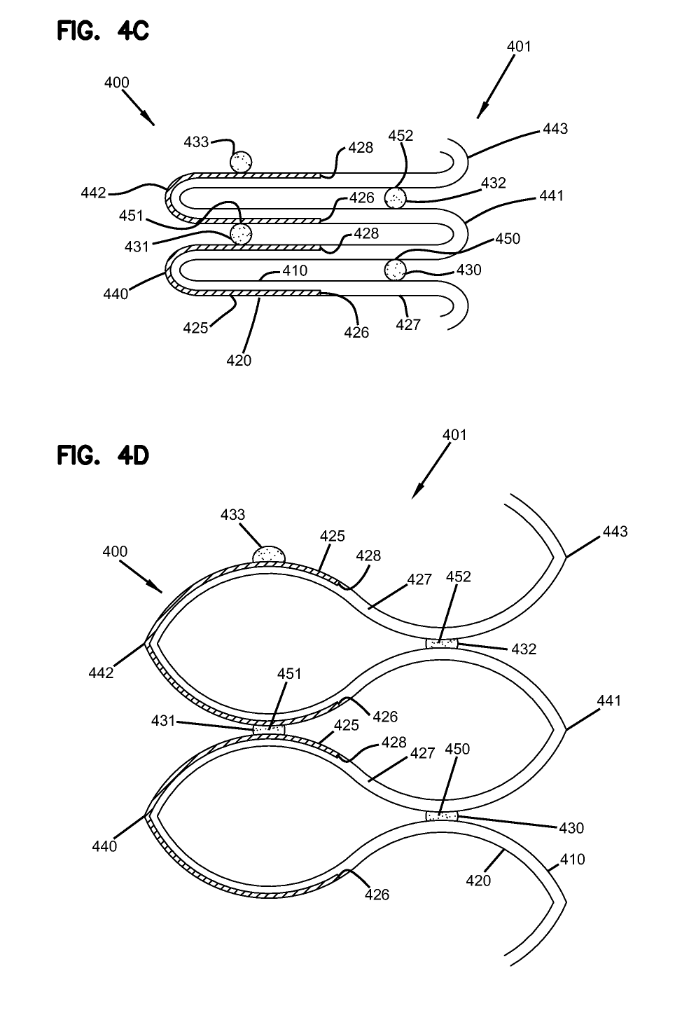

As used herein, the term “cellular blind” or “blind assembly” or “cellular blind assembly” means an assembly having a plurality of tubular, or cellular, elements. In some embodiments the tubular elements are individually formed, and then the elements are assembled to form a blind assembly. In other embodiments the elements are formed contemporaneously and integrally to the blind assembly as the blind assembly is formed. One example of such an embodiment is a “double cell” blind, where a substrate is pleated and the pleats are joined such that a double wall of nested cells are formed. An assembled double-cell configuration is shown, for example, in FIGS. 4C and 4D. Cellular constructions and double-cell constructions are collectively referred to herein as “cellular blinds” or “blind assemblies” or “cellular blind assemblies” where appropriate.

As used herein, the term “substantially” means the same or uniform but allowing for or having minor fluctuations from a defined property, definition, etc. For example, small measureable or unmeasurable fluctuations in a measured property described herein, such as the amount or placement of material used, viscosity, softening point, etc. may result from human error. Other fluctuations are caused by variations in the manufacturing process, thermal history of a formulation, and the like. The cellular blind constructions of the invention, nonetheless, would be said to be substantially possessing the properties as reported.

### Cellular Blind Constructions.

Cellular blinds of the invention are constructed using one or more woven fabrics, nonwoven fabrics, knit fabrics, fiberglass substrates, synthetic polymer sheet substrates, or combination of two or more thereof formed into a plurality of tubular cellular elements. In some embodiments, a plurality of elements is attached in a series by adhesively bonding the elements at their outer surfaces. Alternatively, a plurality of cellular elements is formed by sequential creasing of a substrate with attachment between creases by adhesive bonding such that the plurality of elements, once assembled, forms a pleated blind. The adhesives useful in constructing the cellular blinds are also useful, in embodiments, to form the tubular elements themselves from the substrates by adhesively bonding two ends of a substrate together to form a tube from a flat sheet or fabric. In some embodiments, the adhesives useful in construction the cellular blinds are also useful in adhering other items to the cellular blind assembly to form a finished blind article suitable for installation in a door, window, or the like; such items include lift cords, rails, and panels.

Fabrics useful in forming the cellular elements of the cellular blinds of the invention are flexible, substantially planar, and are formed from a plurality of fibers. Fabric thicknesses range, in various embodiments, from about 50 microns to over 1 millimeter, for example 5 millimeters. Woven fabrics are produced by interlacing two or more sets of yarns, fibers, rovings, or filaments where the elements pass each other essentially at right angles and one set of elements is parallel to the fabric axis. Nonwoven fabrics are made from long synthetic or natural fibers, bonded together by chemical, mechanical, heat or solvent treatment. Examples of nonwovens useful in forming cellular elements include felts. In some embodiments, nonwoven materials useful in the cellular blind constructions of the invention are densified or reinforced by a backing. Knit fabrics are knitted instead of woven; knit fabrics include warp-knit fabrics, such as tricot, and weft-knit fabrics; lace knit, cable knit, or stable knit fabrics are all examples of useful knit fabrics. In various embodiments, woven, nonwoven, or knit fabrics are formed from natural materials such as cotton or wool; or from synthetic substrates such as polyester, nylon, and the like; or from combinations of one or more thereof. One example of a useful fabric for forming cellular blinds is needlepunched nonwoven polyester fabric. Needlepunched nonwovens are created by mechanically orienting and interlocking the fibers of a spunbonded or carded web. This mechanical interlocking is achieved with hundreds or thousands of barbed felting needles repeatedly passing into and out of the web, pulling some fibers along with it, thereby entangling fibers from various parts of the thickness of the fabric to form a more robust construction overall. Another example of a suitable fabric is a “cocoon” fabric, that is, a construction having a film or foil disposed between two layers of a fabric. In embodiments, cocoon fabrics provide complete privacy in a window covering; in embodiments cocoon fabrics are 100% opaque. In embodiments the film or foil is laminated to the fabric to increase the stiffness of the fabric. The film or foil is generally formed from any of the thermoplastic or metal sheet substrates discussed below. In embodiments an adhesive or sizing is employed in conjunction with a laminated cocoon construction. In embodiments, the fabric part of the construction employed in the cocoon fabric is a woven, nonwoven, or knit fabric such as any of the fabrics described above.

Sheet substrates are not fabrics but planar solid sheets generally formed from synthetic resins such as polyester, polyolefin, or nylon, or in some cases from a metal such as aluminum. In some embodiments, a combination of one or more of the substrates described herein is employed to form slats or cellular elements. For example, in some embodiments a nonwoven fabric is laminated to a sheet in order to provide additional privacy or thermal insulating ability in the finished product or to impart additional strength to the fabric. One such example of a fabric laminated to a sheet is a cocoon fabric, which is described above. Other combinations of materials such as those described herein are similarly useful in various cellular blind constructions.

Any of several methods known in the art for assembling cellular blinds from a hot melt adhesive and a fabric or sheet substrate, along with other components conventionally employed to make such blinds, are similarly useful here. For example, methods of assembling cellular blinds set forth in U.S. Pat. Nos. 6,302,982; 6,296,037; 6,164,363; 5,490,553; 5,390,720; or 4,732,630 are useful in conjunction with the hot melt adhesive composition set forth herein to arrive at a cellular blind constructions of the invention.

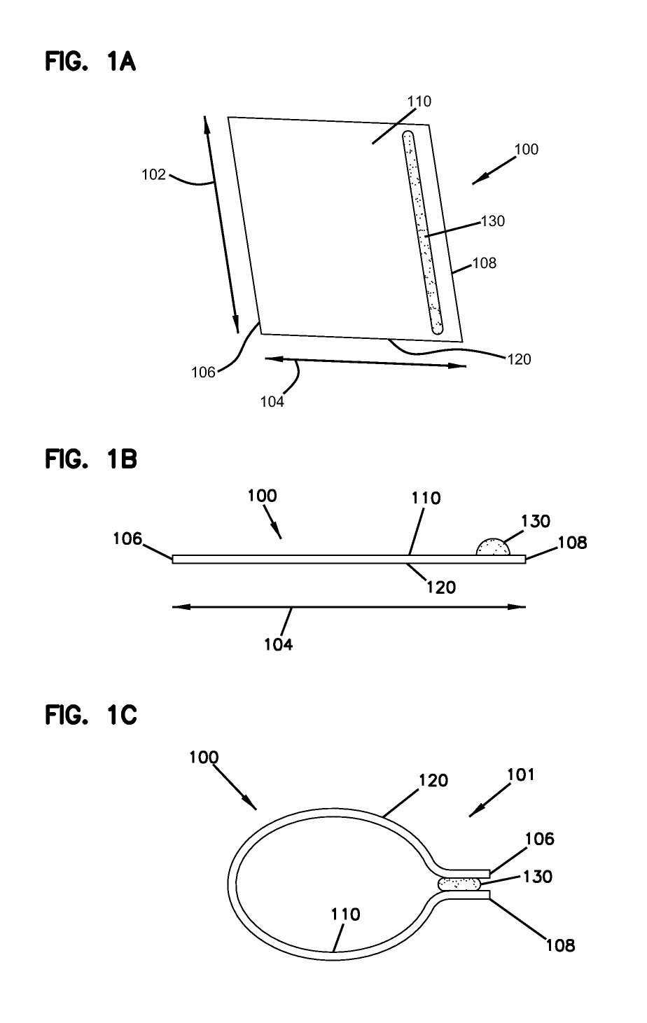

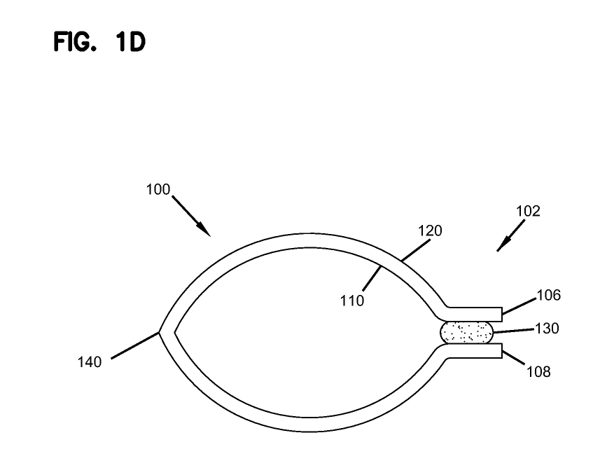

In an illustrative example, FIG. 1 shows a schematic assembly of a representative cellular element of the invention. FIG. 1A is a top view of a fabric sheet 100 having length 102 and width 104, lengthwise edges 106 and 108, first major surface 110, and second major surface 120 (not visible). First major surface 110 further has first contact area 111 and second contact area 112, wherein the first contact area 111 spans the length 102 proximal to the lengthwise edge 108 and second contact area 112 spans length 102 proximal to lengthwise edge 106. Fabric sheet 100 further has a bead of molten hot melt adhesive composition (“adhesive bead”) 130 applied on first contact area 111. The adhesive bead 130 is typically cylindrical in shape as applied by the nozzle and prior to any compression of the bead that is carried out in the manufacturing process, with a diameter of about 0.5 mm to 1 cm, or in some embodiments about 1 mm to 0.5 cm, or in some embodiments about 2 mm to 0.25 cm. FIG. 1B is an edge view of the fabric sheet 100 shown in FIG. 1A along width 104. A nozzle having an orifice delivers the bead of molten adhesive 130 to substrate 100 along first contact area 111. The diameter of the bead 130 is determined by the dimensions of orifice, the rate of flow and the viscosity profile of the molten adhesive in the nozzle, the speed at which the nozzle moves relative to substrate 100 as adhesive 130 is deposited thereon, and the amount of flow or settling of the adhesive bead 130 between application and solidification or additional manipulation. The length of adhesive bead 130 is determined by selection, for example the nozzle can apply adhesive continuously or intermittently. If continuously, then the adhesive bead traverses the length 102 of substrate 100 as is shown in FIG. 1A. If intermittently, more than one bead is employed to traverse the length 102 of substrate 100. FIG. 1B shows a side view along the edge of the substrate defined by the width 104. FIG. 1B shows the substantially cylindrical dimension of the adhesive bead 130 that is defined by the above described factors. For the purposes of the cellular blind elements and blind assemblies of the invention, adhesive beads are about 0.5 mm to 10 mm diameter, for example about 1 mm to 7.5 mm diameter or 1.5 mm to 6.5 mm diameter.

FIG. 1C shows an assembled cellular element 101, wherein the element 101 is assembled from fabric sheet 100. FIG. 1C shows the same edge view of the fabric 100 as shown in FIG. 1B, wherein lengthwise edge 106 of fabric sheet 100 has been folded over such that adhesive bead 130 applied to first contact area 111 contacts the second contact area 112. The folding of fabric sheet 100 is carried out after deposition of adhesive bead 130 and during the open time of the adhesive. Once element 101 is assembled as shown, adhesive bead 130 solidifies such that element 101 is securely held in the assembled configuration during the subsequent use of the cellular element 101 to assemble a cellular blind, and during all subsequent uses of the cellular blind as is described elsewhere in this document. In some embodiments, pressure to element 101 is further provided in the area of fabric sheet 100 where first contact area 111 and second contact area 112 are contacted via adhesive bead 130. Such pressure acts to flatten adhesive bead 130 during the open time of the adhesive, and gives the adhesive bead 130 a lower profile. For example, in embodiments, rollers, bars, a nip, or some other mechanism is employed to “pinch” the area of fabric sheet 100 where first contact area 111 and second contact area 112 are contacted via adhesive bead 130. The pinching must take place during the open time of the molten adhesive. In some such embodiments, the pinching also causes some of the adhesive in adhesive bead 130 to be forced into the interstices between the fibers of fabric sheet 100. In some such embodiments, the pinching mechanism also acts to shorten the open time of the adhesive by cooling it; in some such embodiments the pinching mechanism is cooled to a targeted temperature to tailor the adhesive open time to the manufacturing equipment and speed. In other embodiments, the pinching mechanism is heated and thus application of pressure causes an increase in the open time of the adhesive and/or causes the adhesive to become even further embedded in the interstices between the fibers of the fabric sheet 100.

An alternative embodiment is shown in FIG. 1D. FIG. 1D shows cellular element 102 that is generally assembled in the same manner as element 101 of FIG. 1C, except that a lengthwise crease 140 is formed in fabric sheet 100 about halfway between edge 106 and edge 108. In some embodiments, crease 140 is formed before application of adhesive bead 130 to fabric sheet 100. In other embodiments, crease 140 is formed after application of adhesive bead 130 to first contact area 111 and contemporaneously with the assembly step of folding lengthwise edge 106 of fabric sheet 100 such that the second contact area 112 contacts first contact area 111 and adhesive bead 130. In some such embodiments, formation of the crease 140 is carried out using the same rollers, bars, or nip that pinches the area defined by contact areas 111 and 112 and adhesive bead 130 as is described above.

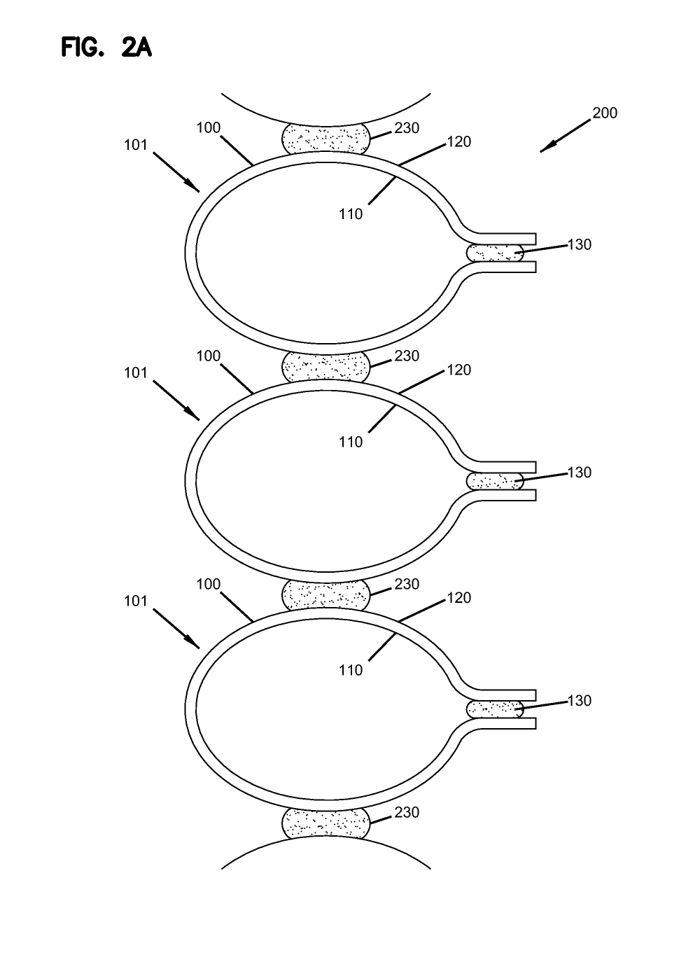

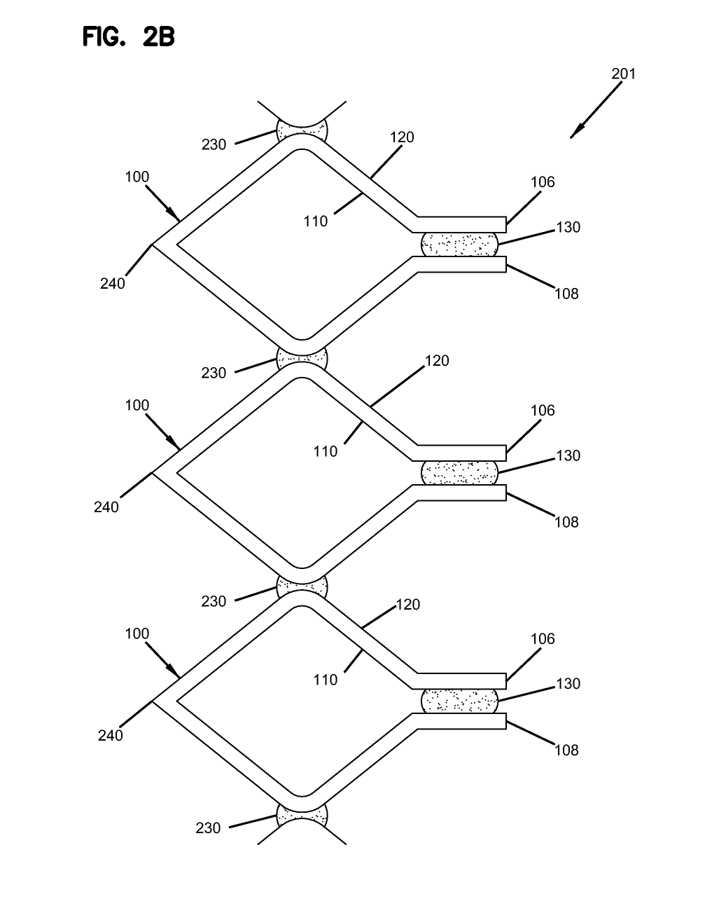

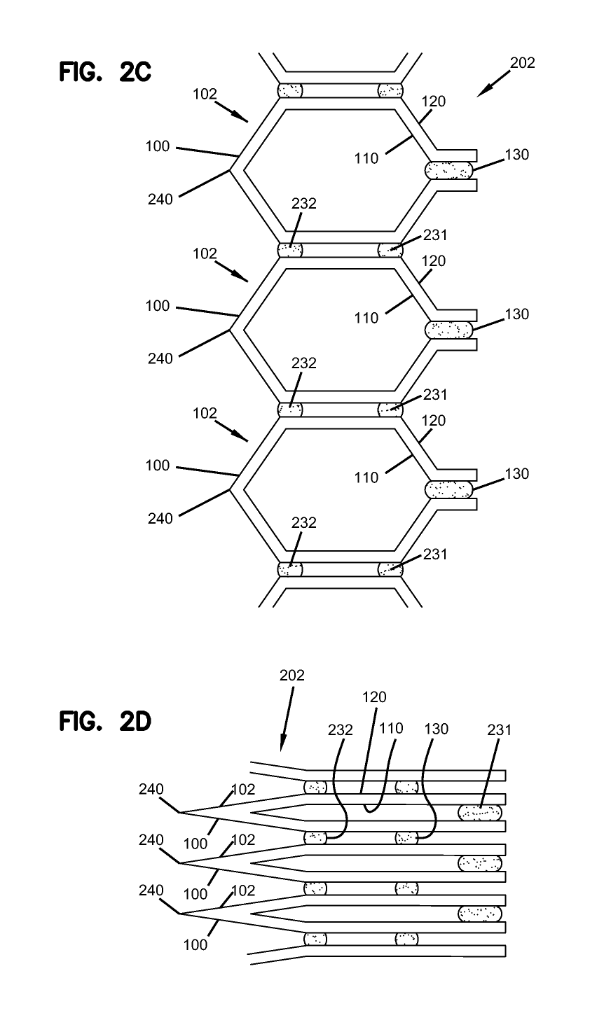

FIG. 2 shows portions of some representative cellular blind assemblies of the invention. The cellular blinds of the invention are made from between 2 and 1000 individual cellular elements, or between about 10 and 500 individual cellular elements, or between about 20 and 200 individual cellular elements. FIG. 2A is an edge view of three cellular elements 101 that are each the same as the cellular elements shown in FIG. 1C, wherein the elements are assembled as part of a cellular blind. Cellular blind assembly 200 shows cellular elements 101 formed from folded-over fabric sheets 100 having first major surfaces 110, second major surfaces 120 and adhesive beads 130 adhering contact areas 111, 112. Also shown on cellular elements 101 are first element contact areas 121 and second element contact areas 122. The element contact areas 121 and 122, like contact areas 111, 112, span the length 102 of the elements 101; however, contact areas 121, 122 are situated on the second major surfaces 120, which are also the outer surfaces of the elements 101. Assembly 200 has additional adhesive beads 230 disposed between cellular elements 101 and adhering each of the first element contact areas 121 to the second element contact areas 122 of each of the adjacent elements 101. Adhesive beads 230 are similar to adhesive beads 130 and in embodiments are formed using the same adhesive composition; in other embodiments adhesive beads 230 are formed using a different adhesive composition than the adhesive composition used to form adhesive beads 130. In some embodiments, adhesive beads 230 are of the same general dimensions of length and diameter as adhesive beads 130; in other embodiments, adhesive beads 230 have different dimensions of length and diameter from adhesive beads 130. In general, however, the diameter of the adhesive beads 230 is within the range of about 1 mm to 1 cm in diameter prior to compression or pinching. To form the assembly 200, an adhesive bead 230 is disposed on first element contact area 121 of a first cellular element 101; then a second element 101 is contacted with second element contact area 122 during the open time of the adhesive. In this manner, elements 101 are stacked together to form assembly 200. The manufacturing process for the assemblies 200 is carried out in any one of several ways and order of adhesive application and formation of cellular elements and the blind assembly, as will be appreciated by one of skill. In an example of a typical manufacturing process, an element 101 is stripe coated with adhesive bead 230 and the next element 101 is contacted thereto during the open time of the adhesive; simultaneously, that next element 101 is stripe coated with the next bead of adhesive 230, and so on. In another typical embodiment, elements 101 are formed concurrently with the formation of the assembly 200.

FIG. 2B shows a portion of an assembly of the invention made using elements 102 of FIG. 1D and formed similarly to assembly 200 of FIG. 2A. Each element 102 of assembly 201 has a crease 240. While the creases 240 are, in some embodiments, formed the same way as for creases 140 of element 100 of FIG. 1D, in a typical embodiment creases 240 are formed by compressing the entire assembly 201 either after formation of the assembly 201 or element-by-element as each element 102 is attached to the assembly. In embodiments where creases 240 are formed by compressing the entire assembly 201 after formation, assembly 201 has as its starting point assembly 200 of FIG. 2A. Compression is carried out using rollers, bars, a nip, or some other mechanism as will be appreciated by one of skill. In embodiments, compression takes place during the open time of the molten adhesive 230, 130, or both. In some such embodiments, the compression also causes some of the adhesive in adhesive beads 130, 230, or both to be forced into the interstices between the fibers of fabric sheets 100 from which elements 102 are formed.

FIG. 2C shows a portion of another assembly of the invention made using elements 102 of FIG. 1D. Each element 102 of assembly 201 has a crease 240. Rather than having a single adhesive bead 230 disposed between elements 102, as is the case with assembly 201 of FIG. 2B, the assembly 202 of FIG. 2C has two beads of adhesive 231, 232 disposed between each element 102. Thus, element contact areas 121, 122 span a portion of the outer surface 120 of elements 102 extending from adhesive bead 231 to adhesive bead 232. The adhesive beads 231, 232 of assembly 202 are spaced such that adhesive bead 231 is about as far from adhesive bead 130 as adhesive bead 232 is from crease 240. While the creases 240 are, in some embodiments, formed the same way as for crease 140 of element 100 in FIG. 1D, in a typical embodiment creases 240 are formed by compressing the entire assembly after its formation or element-by-element as each element 102 is attached to the assembly. Compression is carried out using rollers, bars, a nip, or some other mechanism as will be appreciated by one of skill. In embodiments, compression takes place during the open time of the molten adhesive beads 130, 231, 232, or more than one of these. In some such embodiments, the compression also causes some of the adhesive in adhesive beads 130, 231, 232, or more than one of these to be forced into the interstices between the fibers of fabric sheets 100 from which elements 102 are formed.

FIG. 2D shows the cellular blind assembly 202 in an “open” position with respect to its placement in a window, door, or other architectural opening. In its intended end use application, a cellular blind is raised, or opened when a user wants to let in sunshine, air, or both; and the blind is lowered, or closed when a user desires privacy, shade, or to block some air flow through a window for example. Assemblies 200 of FIG. 2A, 201 of FIG. 2B, and 202 of FIG. 2C are all shown in a configuration corresponding to a lowered, or closed, blind position, where the elements are stretched out. The lowered position provides partial or full coverage of a door, window, etc. In contrast, assembly 202 of FIG. 2D is in a configuration corresponding to a raised, or open, blind position, wherein the elements are compressed to their fullest extent. This gives the blind minimum coverage of a door, window, etc. Additionally, the raised configuration of assembly 202 shows how the blind mechanism will work in conjunction with the affixed contact areas 111, 112, 121, 122 facilitated by the adhesive beads 130, 231, and 232.

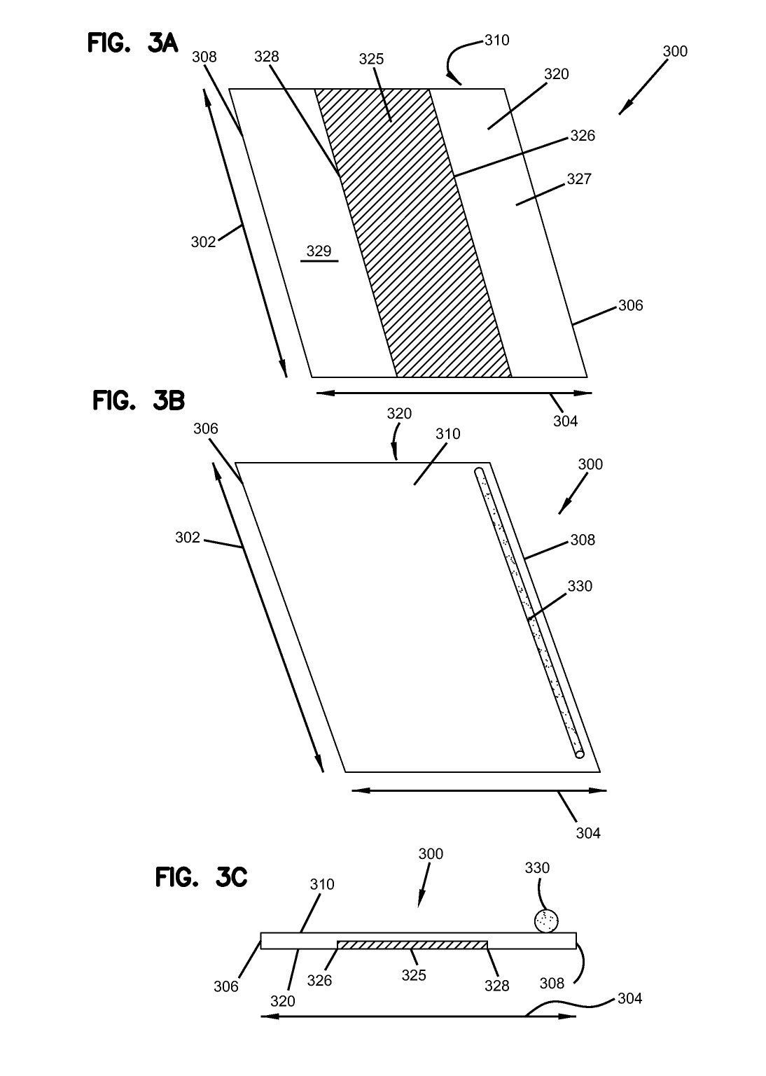

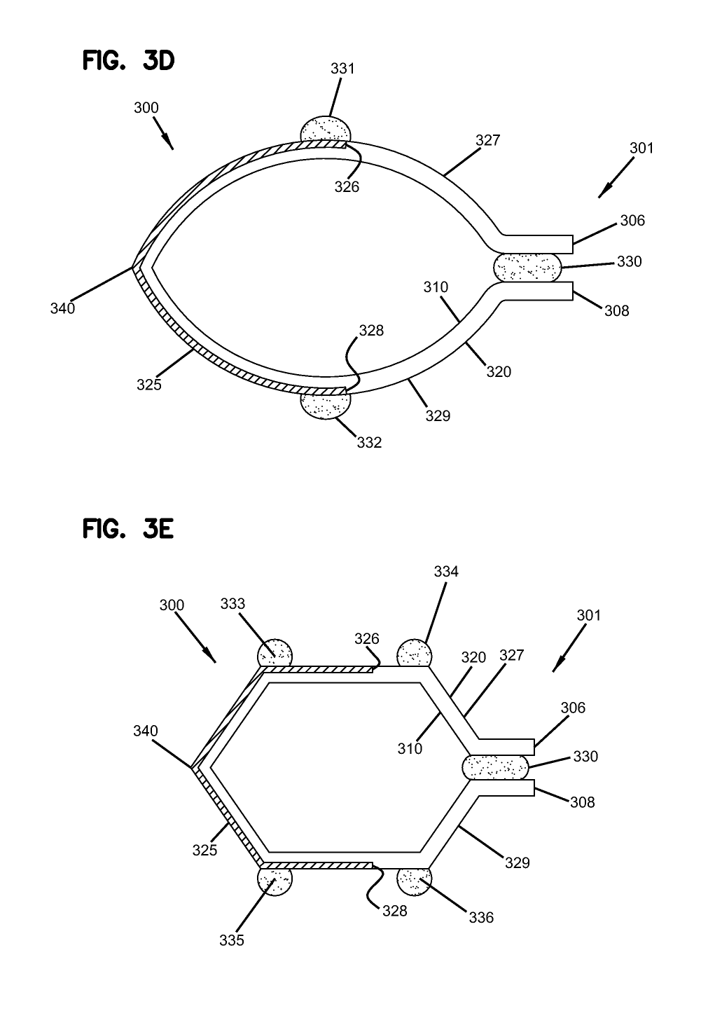

FIG. 3 shows a schematic assembly of another representative cellular blind of the invention. FIG. 3A is a top view of a fabric sheet 300 having length 302 and width 304, lengthwise edges 306 and 308, first major surface 310 (not visible), and second major surface 320. Fabric sheet 300 further has an area 325 that is colored differently from areas 327 and 329 of second major surface 320. The “different” color may be a color that is a darker or lighter shade than areas 327 and 329, or it may be a different color altogether; the color may be printed on surface 320 or dyed/pigmented all the way through and thus constitute differently colored area 325 on both major surfaces 310 and 320. The invention is not particularly limited as to the differently colored aspect of area 325. However, area 325 is generally centered along width 304 and spans a portion of width 304 from a point 326 to point 328. In this particular embodiment, area 325 includes printed-on color wherein the color does not proceed through the entire thickness of sheet 300; further, in this embodiments, areas 327 and 329 are the same color, though in other embodiments they are not the same color.

FIG. 3B shows a view of the first major surface 310 of fabric sheet 300; that is, sheet 300 has been flipped over from the view of FIG. 3A. Fabric sheet 300 has a bead of molten hot melt adhesive composition (“adhesive bead”) 330 applied on a portion of first major surface 310 at first contact area 311, wherein first contact area 311 spans length 302 either on or proximal to edge 308. Fabric sheet 300 also has a second contact area 312, spanning length 302 either on or proximal to edge 306. The cylindrical adhesive bead 330 is typically about 1 mm to 1 cm in diameter as applied from the adhesive applicator nozzle, as in previous embodiments. FIG. 3C is an edge view of the fabric sheet 300 shown in FIG. 3B along width 304. Area 325 is represented as having a color proceeding partway through the thickness of sheet 300 in this embodiment.

FIG. 3D shows a cellular element 301, assembled from fabric sheet 300. The element 301 is similar to cellular element 102 of FIG. 1D, except that element 301 has area 325 proceeding from point 326 to point 328 and areas 327 and 329. FIG. 3D shows the same edge view of the fabric 300 as shown in FIG. 3C, wherein lengthwise edge 306 of fabric sheet 300 has been folded over such that first contact area 311 is contacting second contact area 312, having adhesive bead 330 disposed between the first and second contact areas 311, 312. The folding of fabric sheet 300 is carried out after deposition of adhesive bead 330 and during the open time of the adhesive. Once element 301 is assembled as shown, adhesive bead 330 solidifies such that element 301 is securely held in the assembled configuration during the subsequent use of the cellular element 301 to assemble a cellular blind, and during all subsequent uses of the cellular blind as is described elsewhere in this document. In some embodiments, pressure to element 301 is further provided in the area of contact areas 311, 312 and adhesive bead 330, such as is described for assembly 102 of FIG. 1D. Cellular element 301 further has crease 340 approximately halfway between edge 306 and edge 308. Crease 340 is similar to crease 140 of FIG. 1D and is formed in a similar manner to the methods of creasing described with regard to FIG. 1D. FIG. 3D further shows cellular element contact areas 321 and 322 having adhesive beads 331 and 332, which are applied to sheet 300 before, after, or contemporaneously with application of adhesive bead 330 and formation of element 301. In this embodiment, area 325 extends from point 326—which is situated proximal to, or contiguous to, adhesive bead 331 and element contact area 321—to point 328, which is situated proximal to, or contiguous to, adhesive bead 332 and element contact area 322.

In this manner, a cellular blind assembled with multiple elements 301 attached at element contact areas 321, 322 through adhesive beads 331, 332 will, in its intended end use, have colored area 325 showing on one side of the cellular blind, and the other color 327, 329 showing on the other side of the cellular blind, for example when the blind is in the lowered, or down, position. Many variations are easily envisioned by one of skill; for example, in some embodiments areas 327 and 329 are of different colors. This embodiment leads to a blind that has a solid color resulting from areas 325 of elements 301 on one side of the blind, and a striped coloration on the other side resulting from differently colored areas 327 and 329 of elements 301 that will alternate in a finished cellular blind. In some such embodiments, area 325 is the same color as area 327, or the same color as area 329, or is a different color from both areas 327 and 329. In another embodiment of element 301, point 326 extends partway between adhesive bead 331 and edge 306. Such a blind construction, when multiple elements 301 are assembled, will have a narrow striped or pinstriped appearance on one side of the blind. Similarly, in some embodiments, point 328 extends partway between adhesive bead 332 and edge 308. In embodiments, custom made blinds can be made by mixing colors in ways such as those described by printing the fabric sheet 300 prior to blind assembly. A large sheet having a repeating pattern of colored areas 327, 325, 329 is printed in some embodiments, then cut and assembled to form multiple elements 301 and cellular blinds therefrom. In some such embodiments, a printer is situated in line with the assembly manufacturing equipment to print a white fabric sheet with the appropriate colored areas to give a customized blind.

FIG. 3E shows cellular element 301, assembled from fabric sheet 300. The element 301 is the same as to cellular element 301 of FIG. 3D, except that element 301 has four adhesive beads 333, 334, 335, and 336 instead of the two adhesive beads of FIG. 3D; element contact area 321 extends between adhesive beads 333 and 334; and element contact area 322 extends between adhesive beads 335 and 336. FIG. 3E further shows the location of contact areas 321, 322 and adhesive beads 333, 334, 335, and 336, which are applied to sheet 300 before, after, or contemporaneously with application of adhesive bead 330 and formation of element 301. In this embodiment, area 325 extends from point 326, which is situated between adhesive beads 333 and 334; to point 328, which is situated between adhesive beads 335 and 336. In this manner, a cellular blind constructed from multiple elements 301 will have a similar two-color sided appearance as is described for FIG. 3D. Variations of color schemes are similarly achievable to those described for FIG. 3D; however, in the embodiment shown in FIG. 3E there is more room for error in the manufacturing process. As long as area 325 extends to point 326 anywhere between adhesive beads 333 and 334, and thus anywhere within element contact area 321; and to point 328 anywhere between adhesive beads 335 and 336, and thus anywhere within element contact area 322, the resulting cellular blind will have a solid color appearance on both sides of the cellular blind construction.

FIG. 4 shows a schematic assembly of a representative cellular element of the invention. FIG. 4A is a top view of a fabric sheet 400 having length 402 and width 404, first major surface 410 (not visible), and second major surface 420. Fabric sheet 400 further has a plurality of areas 425 that are colored differently from the plurality of areas 427 of second major surface 420. The “different” color may be a color that is darker or lighter than areas 427, or it may be a different color altogether; the color may be printed on surface 420 or dyed/pigmented all the way through, or be formed by weaving differently colored fibers into the fabric itself, and thus constitute differently colored area 425 on both major surfaces 410 and 420; the invention is not particularly limited as the differently colored aspect of area 425. Areas 425 extend from points 426 to points 428. In this particular embodiment, area 425 includes printed on color and the color does not proceed through the thickness of sheet 400.

FIG. 4B shows a side view of the fabric sheet 400 along width 404. The fabric has been pleated; pleats 440, 441 are formed such that the pleats fall within areas 425, approximately halfway between points 426 and 428. Present on fabric sheet 400 are a plurality of hot melt adhesive beads 430, 431, 432, 433. Adhesive beads 430, 431, 432, respectively, are contacted with contact areas 450, 451, 452, respectively, on fabric 400 as fabric sheet 400 is collapsed or urged into a collapsed conformation by compacting pleats 440, 441, 442, 443. Thus, in a manufacturing embodiment, adhesive bead 430 is applied on first major surface 410 in an area 427. During the open time of the adhesive, the adhesive bead 430 is further contacted with contact point 450 by collapsing sheet 400 at pleat 440, or by decreasing the angle described by the pleat 440. In a subsequent or contemporaneous manufacturing step, adhesive bead 431 is applied on second major surface 420, over an area 425 between point 428 and pleat 440. During the open time of the adhesive, the adhesive bead 431 is further contacted with contact point 451 by collapsing sheet 400 at pleat 441, or by decreasing the angle described by the pleat 441. In a subsequent or contemporaneous manufacturing step, adhesive bead 432 is applied on first major surface 410 in an area 427 on first major surface 410, between point 426 and pleat 441. During the open time of the adhesive, the adhesive bead 432 is contacted to contact point 452 by collapsing sheet 400 at pleat 442, or by decreasing the angle described by the pleat 442. These steps are repeated, for example with adhesive bead 433 and pleat 443, over up to 100 or even up to 1000 times for a single sheet with multiple areas 425, 427 to form a cellular blind assembly having a “double cell” structure. The double cell blind will have one color, represented by area 425, on one side of the blind assembly and a different color 427 on the other side of the blind. The differently colored areas 425, 427 are not a necessary aspect of the double cell assembly, as the blind in embodiments is the same color from the front and back. In some embodiments pleats 440, 441, 442 and other similar pleats are formed contemporaneously with the application of the adhesive beads and contacting of the adhesive beads to the contact points. That is, in some embodiments, the contact points are contacted with the adhesive during the adhesive open time by compressing fabric sheet 400 in a zig-zag fashion that accomplishes both the contacting of the applied adhesive beads with the contact points, and contemporaneously forms the pleats.

FIG. 4C shows a double cell blind assembly 401 at the end of the assembly of fabric sheet 400 depicted in FIG. 4B. Since each pleat of the assembly is collapsed in order to contact one area of fabric sheet 400 with the next area, as is shown in FIG. 4B, the end result is a collapsed or compressed double cell blind conformation of the assembly 401. The double cell blind assembly of FIG. 4C is also in an “open” position with respect to its placement in a window, door, or other architectural opening. Such a conformation is desirable for e.g. storage or shipping of the blind. FIG. 4D shows the same double cell blind assembly 401 in the “closed” position to illustrate certain features of the assembly. The double cell feature is obvious, along with the disposition of areas 425 and 427 to illustrate that the blind will have one color, due to areas 425 facing one major side of the blind, and another color, due to areas 427 facing the other major side of the blind.

In each of the blind assembly embodiments shown in FIGS. 2A, 2B, 2C, 4C, and 4D, as well in other envisioned embodiments of the invention, it is common that the steps of applying adhesive, forming either a blind element or a cellular blind assembly or both simultaneously, and stacking the cellular blind assembly for storage or further assembly e.g. in a frame etc. happen in a rapid contemporaneous or subsequent fashion. Often, less than 5 seconds pass between manufacturing steps. Additionally, as is shown in FIG. 4C, an “open” or collapsed configuration of the blind is a common configuration both for storage of the assembled blind and for subsequent manufacturing steps. Thus, in embodiments, the open time and set time of the adhesive are of critical importance in the ability to use the adhesive in the manufacturing of the blind assemblies of the invention. Often, 5 seconds or less, for example between about 5 seconds and 0.1 second, or between about 3 seconds and 0.5 second, or between about 2 seconds and 1 second pass between application of the molten adhesive formulation to the substrate and stacking the finished blind assembly in an “open” or collapsed configuration for storage or subsequent manufacturing steps.

Where the substrate is a fabric, too long of an adhesive open time results in adhesive flowing completely through layers of the fabric and “blocking” layers together while the blind is in a collapsed conformation. This is particularly true for fabrics with relatively loose weave or low density of fibers per unit area. While some flow of molten adhesive into a fabric layer is beneficial in forming a strong effective adhesive bond, too much results in blocking. In some embodiments, a relatively short open time is critical to prevent blocking of the elements of cellular blind assemblies, or layers thereof. However, in some embodiments it is advantageous to have an open time that is slightly longer than the time that passes between application of the molten adhesive formulation to the substrate and stacking the finished blind assembly in an “open” or collapsed configuration for storage or subsequent manufacturing steps, in order to facilitate some flow of the adhesive into the interstices between fibers of the fabric. It is an advantage of the adhesive compositions employed in the current invention that the specific composition is easily varied and can be selected to target an ideal open time. The selection takes into account factors such as insulation of blind elements by the elements below and above it, openness of a woven, nonwoven, or knit fabric substrate, amount of adhesive applied, and other manufacturing and environmental conditions. The hot melt adhesive compositions employed in the cellular blind assemblies of the invention have an open time of at least about 0.5 seconds, for example about 0.5 seconds to 30 seconds, in embodiments about 1 seconds to 20 seconds, or about 2 seconds to 10 seconds, or about 2 seconds to 5 seconds, or about 0.5 seconds to 5 seconds, or about 0.5 seconds to 2 seconds. In embodiments, the open time allows for some flow into woven, nonwoven, or knit fabrics to enhance effective adhesion of the adhesive in the end use application.

Another critical aspect of the adhesive compositions employed in the cellular blinds of the invention is set time. The set time determines how quickly a load or stress can be applied to the cellular blind after assembly of the blind elements and/or after completing the blind assembly. Another way to understand the set time is that it is the amount of time between application and “grab” of the adhesive to a second substrate or layer of substrate. A fast set time is advantageous in many embodiments for the cellular blinds of the invention because, as is described above, the assembled cellular blind elements are stacked in a collapsed conformation just after application of adhesive. The stacked conformation must be stable in order to prevent slipping or even disassembly of elements or the blind itself. Too long a set time results in some embodiments in the substrate pleats or elements potentially moving relative to one another such that the manufactured blind becomes defective. In response to instability of an assembled blind, additional steps or infrastructure must be installed to keep the assembled blind in the proper conformation until the adhesive “sets”.

A tailorable set time is a key property of the adhesive compositions employed in the cellular blinds of the invention. In some embodiments, the adhesive composition includes only a copolymer of propylene and a functionalized polyolefin. In such embodiments, the adhesive compositions have effective set times of about 10 seconds or less, for example about 2 seconds to 8 seconds. Such compositions are particularly useful where, for example, greater penetration between fibers of a cellular blind fabric is desirable due to the need for greater adhesion, for example where the fabric employed in the blind assembly is relatively stiff. For example, some fabrics employed in cellular blind constructions include a sizing. Sizing coats the fibers in a fabric and in many embodiments stiffens the fabric to the extent suitable for use in a cellular blind assembly; in other embodiments sizing improves printing receptivity or provides one or more other desirable properties. In some embodiments, whether due to increased stiffness or a low fiber surface energy, the blind assemblies of the invention benefit from the enhanced adhesion imparted by increased interfiber penetration of the molten hot melt adhesive, wherein a longer set time provides the desired level of penetration. It is an advantage of the instant invention that the adhesive formulation is easily modified to provide set times tailored for the specific needs of the fabrics employed in the blind assembly construction. Thus, where the adhesive compositions further include a nucleating agent, the compositions have effective set times of about 5 seconds or less, for example about 0.1 second to 5 seconds, in embodiments about 0.1 second to 3 seconds, and in some embodiments about 0.2 second to 2 seconds.

The hot melt adhesive compositions of the invention are be applied to each cellular element using any of a number of known and conventional techniques. In embodiments, a coating head or nozzle, with associated equipment for preheating and holding a reservoir of molten adhesive composition is used. Such equipment is manufactured, for example, by the Nordson Corp. of Westlake, Ohio; ITW Dynatec of Hendersonville, Tenn.; and Hot Melt Technologies of Rochester Hills, Mich. In embodiments, the hot melt adhesive composition is applied as beads, fine lines, dots, or patches; in a continuous or intermittent fashion; or generally in any fashion in which conventional hot melt adhesive formulations are applied in the manufacture of cellular blind elements. It is an advantage of the invention that the hot melt adhesive compositions employed in the assembly of the cellular blinds is applied with ease, for example without mixing a two-part formulation followed by a limited open time. Further, there is no curing required for the adhesive compositions, for example by further heating the compositions after application to the substrate. Excellent adhesive open time, set time, and ultimate strength are afforded by simply melting the adhesive composition, applying it to the substrate, and attaching the next substrate or layer of substrate.

The hot melt adhesives of the invention are extruded in a molten state onto a first tubular cellular element, the element having an outer surfaces and a longitudinal axis, so as to traverse at least a portion of the outer surface along the longitudinal axes thereof. The second cellular element is applied on top of the extruded adhesive, during the adhesive open time. The open time is the time during which the molten adhesive remains substantially above its melting temperature, upon application onto a substrate at typical ambient temperatures. The application of the second cellular element to the adhesive results in bonding of the first and second elements.

In embodiments the adhesive formulation, once in place such that it is employed to structurally bond the tubular elements of the cellular blind, does not soften at temperatures less than about 71° C. (160° F.). In some such embodiments, the adhesive formulation does not soften at temperatures less than about 135° C. (275° F.). Conventionally it is understood by those of skill that a remelt temperature of at least 163° C. (325° F.) is necessary for use in the environment in which the cellular blind is ultimately placed, because temperatures approaching 135° C. (275° F.) are obtained in air spaces between windows and expanded cellular insulation or blinds during daylight hours on sunny days. Conventional adhesives that remelt at less than approximately 163° C. will typically soften at temperatures as low as 121° C. (250° F.), and the cellular elements can begin to come apart, particularly the upper elements that bear the weight of the elements below. Conventional adhesives used in cellular blind construction must be crosslinked in some way, by mixing a two-part curable adhesive or by post curing, in order to provide such stability to remelting.

Additionally, the adhesive employed in such applications are UV stable, or resistant, that it does not undergo yellowing or cracking, or become brittle after appreciable UV exposure. Because the adhesive disposed between tubular elements of cellular blind constructions is exposed directly to the radiation, or is exposed to radiation passing through e.g. a window or door, many adhesive compositions are unsuitable for this challenging application. Many curable polyurethane-based hot melt adhesives have aromatic compounds, and these formulations tend to yellow or even turn a brownish color, and may even become brittle or crack after a period of exposure to direct sunlight.

### Description of the Hot Melt Adhesive Compositions.

In various embodiments, the hot melt adhesive compositions useful in the cellular blind constructions of the invention include a polypropylene copolymer, which is a copolymer of propylene and at least one comonomer selected from the group consisting of ethylene and C₄ to C₂₀ α-olefins, wherein the copolymer has a propylene content of greater than 65 mole %, a Brookfield viscosity at 190° C. of about 200 cP to 25,000 cP, and a density of about 0.860 g/cm³ to 0.868 g/cm³. In embodiments, the propylene copolymers are polymerized using a metallocene catalyst and associated polymerization techniques. Metallocene catalysts are well known in the patent and non-patent literature and have been used to form propylene polymers having varying but reproducible stereoregular content. Suitable catalysts include bis-metallocene complexes having cyclopentadienyl ligands capable of producing polymerized propylene sequences that are either isotactic or syndiotactic. A list of some metallocene ligands, as well as cocatalysts useful in conjunction with the metallocene catalysts in the syntheses of stereoregular propylene polymers, is found in U.S. Pat. No. 6,747,114. Some transition metal compound components are described in U.S. Pat. Nos. 5,145,819; 5,243,001; 5,239,022; 5,329,033; 5,296,434; 5,276,208; 5,672,668, 5,304,614 and 5,374,752; and in European Patent Publication Nos. EP549900 and EP576970. Further, any of the techniques described in these documents, as well as others widely found in the art, can be employed to make propylene copolymers that are useful in the hot melt adhesive compositions useful in the window blind constructions of the invention.

In embodiments, the propylene copolymer is a copolymer of propylene and ethylene. In other embodiments, the propylene copolymer is a copolymer of propylene and an α-olefin (linear 1-alkene). In some such embodiments the α-olefin is 1-butene. In other embodiments the α-olefin is 1-hexene. In still other embodiments, the propylene copolymer includes propylene, ethylene, and an α-olefin. In embodiments, the average propylene content of the propylene copolymer is about 80 mol % to 99.9 mol %, in some embodiments about 90 mol % to 99 mol %. In embodiments, the propylene copolymer is semicrystalline when in a solid state. In embodiments some repeat unit sequences in the propylene copolymer are isotactic; in other embodiments some repeat unit sequences in the propylene copolymer are syndiotactic. In embodiments, crystalline content in the propylene copolymer is derived from isotactic or syndiotactic block-like sequences.

The propylene copolymers useful in the hot melt adhesive compositions have a tensile strength measured according to ASTM E28 of about 50 to 600 psi, in some embodiments about 75 to 450 psi, in some embodiments about 300 to 4000 kPa, and in some embodiments 500 to 3100 kPa. The propylene copolymers have a Brookfield viscosity measured at 190° C. according to ASTM D3236 (spindle #27, 5 RPM on a Brookfield viscometer) of about 200 cP to 25,000 cP, in embodiments about 400 cP to 10,000 cP, in embodiments about 600 cP to 5000 cP, and in embodiments about 700 cP to 2000 cP. The propylene copolymers have a density in solid form of about 0.860 g/cm³ to 0.868 g/cm³. The propylene copolymers have a peak melting temperature of about 131° C. to 170° C.

In embodiments, the propylene copolymer is a copolymer of propylene and at least one comonomer selected from the group consisting of ethylene and C₄ to C₂₀ α-olefins, wherein the copolymer has a propylene content of greater than 65 mole %, a weight average molecular weight (M_{W}) of about 15,000 g/mol to 200,000 g/mol, a melt index of about 7 dg/min to 3000 dg/min as measured by ASTM D 1238(B), a polydispersity (weight average molecular weight/number average molecular weight ratio, or M_{w}/Mₙ) of about 1.5 to 3, a melt flow rate of 250 dg/min or greater at 230° C., and a heat of fusion of about 30 J/g to 80 J/g as determined by differential scanning calorimetry (DSC). Examples of propylene copolymers that are useful in the hot melt adhesive compositions include LINXAR™ 127, VISTAMAXX™ 2230, and VISTAMAXX™ 8816, all of which are available from ExxonMobil Chemical of Houston, Tex.

In embodiments, the propylene copolymer is a blend of more than one propylene copolymer. The one or more propylene copolymers differ, in various embodiments, in one or more parameters such as degree of crystallinity, molecular weight, degree of branching, tacticity, monomer composition, and polydispersity. These parameters give rise to differences in physical parameters such as density, tensile strength, and degree of crystallinity, among others. Blends of more than one propylene copolymer are employed in various embodiments of the hot melt adhesive compositions in order to provide for or optimized physical properties, lower cost, or for some other reason or combination of reasons. In some embodiments, for example, a lower molecular weight, high density propylene copolymer is blended with a higher molecular weight propylene copolymer in order to provide a combination of rapid effective set time with high impact strength, improved peel and/or shear adhesion performance, low temperature adhesive performance, or a combination of one or more thereof.

The total amount of the one or more propylene copolymers present in the hot melt adhesive compositions range from about 70 wt % to 99 wt % based on total weight of the composition, or about 80 wt % to 95 wt % based on total weight of the composition. The hot melt adhesive compositions are not particularly limited as to ratios of the two or more propylene copolymers where such blends are employed and can range, for example, from 1:99 by weight to 99:1 by weight of two propylene copolymers, or 10:90 by weight to 90:10 by weight for two propylene copolymers, or 25:75 to 75:25 for two propylene copolymers.

In various embodiments, the hot melt adhesive compositions useful in the cellular blind constructions of the invention include about 0.1 wt % to 10 wt % of a functionalized polyolefin, which is a polyethylene, polypropylene, or copolymer thereof having functional groups derived from maleic anhydride or acrylic acid. The functionalized polyolefin improves adhesion to polar polymers (such as cotton, wool, nylon, or polyester) and wood or metal substrates useful as some portion of the tubular cellular elements in the blind constructions of the invention. Because the functionalized polyolefins are high polymers and not low molecular weight tackifiers—such as terpenes and the like—they are chain entangled with the propylene copolymer and do not tend to flow or leach out at temperatures as high as 160° F. (71° C.). Additionally, maleic anhydride functional polyolefins impart improved low temperature adhesion—that is, adhesion at winter temperatures encountered in the extreme northern or southern areas of the globe—to the hot melt adhesive compositions. In some embodiments, the maleic anhydride functional polyolefins have about maleic anhydride functionality corresponding to saponification numbers of about 20 mg KOH per gram of polymer to 90 mg KOH per gram of polymer, in some embodiments about 40 mg KOH per gram of polymer to 80 mg KOH per gram of polymer. In some embodiments, a functionalized polyolefin is incorporated into one or more hot melt adhesive compositions at about 0.1 wt % to 10 wt % based on the total weight of the composition, or at about 1 wt % to 8 wt % based on the total weight of the composition, or at about 3 wt % to 7 wt % based on the total weight of the composition.

Examples of some functionalized polyolefins that are usefully employed in the hot melt adhesive compositions of the invention include Honeywell A-C® 596 maleic anhydride functionalized polypropylene, available from Honeywell International Inc. of Morristown, N.J.; POLYBOND® acrylic acid or maleic anhydride functionalized polypropylenes, available from Chemtura Corp. of Middlebury, Conn.; and EPOLENE® maleic anhydride functionalized polyethylenes, available from Westlake Polymers LLC of Houston, Tex.; FUSABOND® resins available from E. I. du Pont de Nemours and Company of Wilmington, Del.; PLEXAR® anhydride functional polyethylene resins from LyondellBasell Industries of Houston, Tex.; OREVAC® maleic anhydride grafted polyolefins available from Arkema Inc. North America, of King of Prussia, Pa.; EXXELOR® polyolefins available from ExxonMobil Chemical of Houston, Tex.; of or any of the polymers described in U.S. Pat. Nos. 5,955,547 and 6,046,279.

An alternative route to adding functionalized polyolefins, such as those described above, to the hot melt adhesive compositions is to carry out direct chemical modification of the propylene copolymer, or blend thereof, that is used in the hot melt adhesive composition. In one such embodiment, the semicrystalline propylene copolymers, or a portion thereof to be used in the hot melt adhesive composition, are partially maleated. Methods used to maleate propylene homopolymers or copolymers are found, for example, in U.S. Pat. Nos. 4,315,863; 5,001,197; 5,420,303; 7,256,236; 7,659,346. Any of the methods and amounts of maleation described in these and other references in the art are useful in conjunction with one or more components of the hot melt adhesive compositions to impart maleic anhydride functionality thereto, resulting in excellent adhesion of the compositions to the window blind elements in the window blind constructions of the invention.

The hot melt adhesive compositions useful in the cellular blind constructions of the invention optionally include a nucleating agent. Nucleating agents are employed to shorten the set time of the hot melt adhesives when constructing the window blind constructions of the invention. In some embodiments of the invention where knitted, woven, or nonwoven fabrics are employed to make the blind constructions, bleed-through of the hot melt adhesive occurs if the adhesive remains in a substantially molten state for a sufficiently long period of time to penetrate the thickness of the fabric. In such embodiments, nucleating agents are employed to shorten the set time of the adhesives. The nucleating agents are low molecular weight polyethylene homopolymers. In some embodiments the polyethylene waxes are metallocene polymerized using techniques similar to those described above for the propylene copolymers. In embodiments, the nucleating agents are low molecular weight metallocene polymerized polyethylene homopolymers. The Brookfield viscosity of the nucleating agents ranges from about 20 cP to 500 cP at 140° C. The density of the nucleating agents in solid form is about 0.95 g/cm³ to 1.00 g/cm³ or about 0.96 g/cm³ to 0.99 g/cm³, or about 0.96 g/cm³ to 0.98 g/cm³. The Mettler drop point of the nucleating agents is about 110° C. to 135° C., or about 125° C. to 135° C. Where present in the hot melt adhesive compositions useful in forming the cellular blind constructions of the invention, the nucleating agent is present at about 0.05 wt % to 15 wt % based on total weight of the composition, or at about 1 wt % to 10 wt % based on total weight of the composition, or at about 3 wt % to 7 wt % based on total weight of the composition.

One example of a nucleating agent useful in the adhesive compositions is LICOCENE® PE 4201, available from Clariant International Ltd. of Muttenz, Switzerland. LICOCENE® PE 4201 is a metallocene catalyzed polyethylene wax having a density of 0.97 g/cm³, a viscosity of 40 cP to 80 cP at 140° C., and a Mettler drop point of 125° C. to 130° C. according to ASTM D3954. Another example of a nucleating agent useful in the adhesive compositions is LICOCENE® PE 5301, available from Clariant International Ltd. LICOCENE® PE 5301 is a metallocene catalyzed polyethylene wax and has a density of 0.97 g/cm³, a viscosity of about 350 cP at 140° C., and a drop point of 128° C. to 133° C. according to ASTM D3954. Another example of a nucleating agent useful in the adhesive compositions is POLYWAX™ 3000 polyethylene homopolymer, available from Baker Hughes Incorporated of Sugar Land, Tex. POLYWAX™ 3000 has a density of 0.98 g/cm³, a viscosity of 130 cP at 149° C. according to a modified ASTM D88 procedure, and a melting point of 129° C. according to ASTM D127. Another example of a nucleating agent useful in the adhesive compositions is POLYWAX™ 2000 polyethylene homopolymer, available from Baker Hughes Incorporated. POLYWAX™ 2000 has a density of 0.97 cm³, a viscosity of 50 cP at 149° C. according to a modified ASTM D88 procedure, and a melting point of 126° C. according to ASTM D127. Another example of a nucleating agent useful in the adhesive compositions is POLYWAX™ 1000 polyethylene homopolymer, available from Baker Hughes Incorporated. POLYWAX™ 1000 has a density of 0.96 cm³, a viscosity of 15 cP at 149° C. according to a modified ASTM D88 procedure, and a melting point of 113° C. according to ASTM D127. Another example of a nucleating agent useful in the adhesive compositions is POLYWAX™ 850 polyethylene homopolymer, available from Baker Hughes Incorporated. POLYWAX™ 850 has a density of 0.96 cm³, a viscosity of 13 cP at 149° C. according to a modified ASTM D88 procedure, and a melting point of 107° C. according to ASTM D127. Another example of a nucleating agent useful in the adhesive compositions is Honeywell A-C® 820A polyethylene homopolymer, available from Honeywell International Inc. A-C® 820A has a density of 0.97 g/cm³, a Brookfield viscosity of 50 cP to 150 cP at 140° C., and a Mettler drop point of 123° C. to 133° C.

Additional components employed in some embodiments of the hot melt adhesive compositions include antioxidants, UV stabilizers, and free radical scavengers. These materials are commonly employed in hot melt adhesive formulations in order to increase thermal and/or UV stability of thereof. Conventionally, such materials are useful in hot melt adhesive compositions because during use—that is, while awaiting application—the compositions are often held at high temperatures for extended periods of time, for example in a holding tank or cartridge. Generally, hot melt adhesive formulations are heated to between about 110° C. and 200° C., in some embodiments between about 130° C. and 170° C., in still other embodiments between about 150° and 175° C., prior to application in order to reduce viscosity of the composition. The formulations must be stable at these temperatures to allow for extended periods as a molten product prior to application.

In the current cellular blind constructions of the invention, both thermal stabilization and UV stabilization are important after application of the adhesive. As explained above, the cellular blinds and the adhesive compositions disposed between tubular blind elements are routinely exposed to direct sunlight and/or temperatures of about 70° C. (160° F.) or higher; such exposure often occurs for extended periods of several hours daily. While the polyolefin basis for the adhesive compositions are advantageous in terms of both thermal and UV stability, enhanced stability is further realized by including one or more thermal or UV stabilizing materials.

In embodiments, antioxidants such as hindered phenols are employed in the hot melt adhesive compositions of the invention. Representative hindered phenols include 1,3,5-trimethyl-2,4,6-tris(3-5-di-tert-butyl-4-hydroxybenzyl)benzene; pentaerythritol tetrakis-3(3,5-di-tert-butyl-4-hydroxyphenyl)propionate; n-octadecyl-3(3,5-ditert-butyl-4-hydroxyphenyl)propionate; 4,4′-methylenebis(4-methyl-6-tert butylphenol); 4,4′-thiobis(6-tert-butyl-o-cresol); 2,6-di-tert-butylphenol; 6-(4-hydroxyphenoxy)-2,4-bis(n-ocytlthio)-1,3,5-triazine; 2,4,6-tris(4-hydroxy-3,5-di-tert-butyl-phenoxy)-1,3,5-triazine; di-n-octadecyl-3,5-di-tert-butyl-4-hydroxybenzylphosphonate; 2-(n-octylthio)ethyl-3,5-di-tert-butyl-4-hydroxybenzoate; and sorbitol hexa-(3,3,5-di-tert-butyl-4-hydroxy-phenyl)propionate. One example of a useful hindered phenol is IRGANOX® 1010 (pentaerythritol tetrakis(3-(3,5-di-tert-butyl-4-hydroxyphenyl)propionate), available from BASF Corp. of Florham Park, N.J.), and free radical scavengers such as, but not limited to, butylated hydroxytoluene or “BHT”, and butylated hydroxyanisole or “BHA”, available from multiple vendors. Any of these materials are advantageously added to the hot melt adhesive compositions to further enhance thermooxidative stability. In embodiments, UV light absorbers are also employed in the hot melt adhesives. In embodiments, benzotriazole type UV absorbers are employed. For example, 2-(2′-Hydroxy-3′,5′-di-tert-amylphenyl)benzotriazole, sold under the trade name BLS® 1328 (available from Mayzo Inc. of Suwanee, Ga.); and hindered amine light stabilizers (HALS) based on derivatives of 2,2,6,6-tetramethyl piperidine, such as BLS® 1770 (also available from Mazyo Inc.) are useful. Any of these materials are advantageously added to the hot melt adhesive compositions to further enhance thermooxidative stability.

Where employed, the antioxidants and UV light absorbers are generally added to the hot melt adhesive compositions in amounts ranging from about 0.01% to 5% by weight of the composition, or about 0.1% to 1.5% by weight of the composition, or about 0.20% to 1.0% by weight of the composition.

The hot melt adhesive compositions are characterized by the absence of conventional tackifying resins, conventional waxes, and conventional plasticizers. Tackifying resins, or tackifiers, typically have low molecular weights and are resinous, and have glass transition and softening point temperatures well above typical room temperatures but often below 150° C., below 120° C., or even about 100° C. and below. As such, conventional tackifiers can easily reach their softening point while employed in the cellular blinds of the invention, that is, while the finished blind is situated in a window or door. Such softening can cause the adhesives to soften, the tackifier to flow and penetrate woven, nonwoven, or knit fabrics, or both. Some conventional tackifying resins are based on natural products, for example terpenes, which are based on polymerized α- or β-pinene based compounds. Other conventional tackifiers are petroleum-based hydrocarbon resins, for example those sold by ExxonMobil Chemical under the trade name ESCOREZ®; those sold by Arizona Chemical Co. of Jacksonville, Fla. under the trade name SYLVARES™; those sold by Cray Valley of Paris, France under the trade name WINGTACK®; those sold by Pinova, Inc. of Brunswick, Ga. under the trade name PICCOLYTE®; and those sold by Eastman Chemical Co. of Kingsport, Tenn. under the trade names EASTOTAC® and REGALREZ®. It is important to note that the hot melt adhesives employed in the cellular blinds of the invention do not require a tackifier to provide excellent adhesion to the substrates employed as tubular blind elements.

The hot melt adhesive compositions employed in the cellular blind constructions of the invention are characterized by the substantial absence of conventional waxes. Conventional waxes are generally added to hot melt adhesive compositions to adjust the melt viscosity, or improve the low temperature performance of the adhesive. Like the tackifiers, the waxes tend to soften and/or flow at the high temperatures to which such blinds are subjected and thus, for the same reasons, are unacceptable to use in the adhesives. Conventional waxes include petroleum based paraffin waxes, Fischer-Tropsch waxes, and low molecular weight polyethylene or polypropylene waxes. Paraffin waxes are hydrocarbon mixtures with the general formula CₙH₂ₙ₊₂ wherein 20≦n≦40; they are available from a broad range of sources including consumer sources. Fischer-Tropsch waxes are synthetic waxes produced by the Fischer-Tropsch process, which is a method for the synthesis of hydrocarbons and other aliphatic compounds from a mixture of hydrogen and carbon monoxide in the presence of a catalyst. Fischer-Tropsch waxes are also available from a number of sources. Low molecular weight polyethylene or polypropylene waxes, other than those polymerized by metallocene catalysts, are low molecular weight polymers made by direct polymerization of ethylene and propylene under conditions whereby molecular weight is controlled. These polymer waxes are available from a number of sources.

The hot melt adhesive compositions employed in the cellular blind constructions of the invention are characterized by the substantial absence of plasticizers. Plasticizers are conventionally low molecular weight compounds, such as aromatic or aliphatic mono-, di-, or tri-esters, modified petroleum or vegetable oils, modified glycols or polyethers, and the like. Plasticizers work by embedding themselves between the chains of polymers, increasing the “free volume” between the chains, and thus significantly lowering the glass transition temperature of the composition and/or the base polymer employed in the composition and making the adhesive softer. This means that the adhesive composition will be more flexible, particularly at low temperatures, though its strength and hardness will decrease as a result. Additionally, at use temperatures, many plasticizers leach out of the adhesive and evaporate or flow as a liquid out of the adhesive matrix. This can even happen at lower end use temperatures in some cases, for example at 20° C.

Additional components employed in some embodiments of the hot melt adhesive compositions include one or more additional polymers. The one or more additional polymers are added to complement the propylene copolymer as the base polymer. The one or more additional polymers must be compatible with the propylene copolymer; that is, they do not undergo substantial phase separation from the hot melt adhesive composition either in the melt or during and after solidification and crystallization of the propylene copolymer. Other than this limitation, the specific type and the amount of the additional polymer(s) used in the hot melt adhesive compositions of the invention are not particularly limited. In some embodiments, the one or more additional polymers is a higher molecular weight polymer and increases the cohesive strength of the hot melt adhesive compositions of the invention. In some embodiments, the addition of one or more additional polymers increases the peel strength of the hot melt adhesive compositions of the invention after application to the intended substrate. In some embodiments, the one or more additional polymers are lower in crystalline content than the propylene copolymer under the same conditions. In some embodiments, the one or more additional polymers are elastomers. In some embodiments, the one or more additional polymers increase the hot tack of the hot melt adhesive compositions of the invention; that is, the level of “grab” of the compositions to an intended substrate when molten. In some embodiments, the one or more additional polymers increase the low temperature adhesion performance of the of the hot melt adhesive compositions of the invention. In some embodiments, the one or more additional polymers are added to decrease the overall cost of the compositions of the invention without compromising key physical properties as otherwise described herein. In embodiments of the hot melt adhesive compositions where one or more additional polymers are employed, the one or more additional polymers are included in the composition at about 0.01 wt % to 30 wt % based on the total weight of the composition; or about 1 wt % to 20 wt % based on the total weight of the composition; or about 3 wt % to 10 wt % based on the total weight of the composition.

Some examples of additional polymers useful in the hot melt adhesive compositions include polyolefins such as polyethylene, polypropylene, and copolymers thereof such as polypropylene based elastomers sold by ExxonMobil Chemical of Houston, Tex. under the trade name VISTAMAXX™ and polyethylene based elastomers such as those sold by Dow Chemical Company of Midland, Mich. under the trade names AFFINITY™ and ENGAGE™. Other useful additional polymers include block copolymers such as those sold by Kraton Polymers U.S. LLC of Houston, Tex. under the trade name KRATON® G; those sold by Kuraray Co., Ltd. of Tokyo, Japan under the trade name SEPTON®; those sold by Polimeri Europa of Milan, Italy under the trade name EUROPRENE® SOL T; those sold by Dexco Polymers LP of Plaquemine, La. under the trade name VECTOR™; and others, including any of the block copolymers described in U.S. Pat. No. 6,846,876.

Other types and amounts of additives usefully employed with the hot melt adhesives employed in the cellular blind constructions of the invention are not particularly limited and include, in various embodiments, colorants (dyes or pigments), bleaches, surfactants such as cationic, anionic, zwitterionic, or nonionic surfactants, and fillers as well as combinations of one or more thereof. In various embodiments, where they are used, such additives are each added to the hot melt adhesive compositions at amounts of about 0.001 wt % to 5 wt % based on the total weight of the composition, or about 0.01 wt % to 3 wt % based on the total weight of the composition.

The hot melt adhesive compositions are formed using conventional techniques. Procedures and methods for formulating hot melt adhesive compositions are well known in the art. Any of these procedures may be used to blend and prepare the hot melt adhesive compositions. The method of blending and preparing the hot melt adhesive compositions is not particularly limited. Descriptions of those procedures and methods are reviewed, for example, in Skeist, Irving, Handbook of Adhesives, Van Nostrand Reinhold International; 3rd edition (1990).

The hot melt adhesive compositions have melt rheology and thermal stability suitable for use with conventional hot melt adhesive application equipment. The blended components of the hot melt adhesive compositions have low melt viscosity at the application temperature, thereby facilitating flow of the compositions through a coating apparatus, e.g., coating die or nozzle, without resorting to the inclusion of solvents or extender oil into the composition. Melt viscosities of the hot melt adhesive compositions are between 100 cP and 10,000 cP measured at 180° C. according to ASTM D 3236. In embodiments, the melt viscosity at 180° C. is about 300 cP to 5000 cP according to ASTM D3236. The hot melt adhesive compositions have a Ring and Ball softening point, according to ASTM D638 of about 120° C. to 150° C., in some embodiments about 135° C. to 145° C.

### Application of the Hot Melt Adhesives

The hot melt adhesive compositions of the invention are be applied to a desired substrate using any of the techniques known in the art, including conventional techniques used in packaging. In embodiments, a coating head or nozzle, with associated equipment for preheating and holding a reservoir of molten adhesive composition is used. Such equipment is manufactured, for example, by the Nordson Corp. of Westlake, Ohio; ITW Dynatec of Hendersonville, Tenn.; and Hot Melt Technologies of Rochester Hills, Mich. In embodiments, the hot melt adhesive compositions of the invention are applied as beads, fine lines, dots, patches, or spray coatings; in a continuous or intermittent fashion; or generally in any fashion in which conventional hot melt adhesive formulations are applied. Spray-on application involves delivery of adhesive from a plurality of narrow orifices in the form of fibers, threads or filaments having a substantially circular cross section with a diameter less than 0.12 cm, in some embodiments about 0.02 to 0.002 cm. Fine line or spiral spray patterns are used in various embodiments. The hot melt adhesives of the invention are extruded, whether by spray or other application apparatuses, in a molten state onto a first substrate. The second substrate is then applied on top of the adhesive to bond the first and second substrates together. In some embodiments wherein the first, second, or both substrates are porous (for example, a polypropylene nonwoven, or a cellulose tissue), more than two substrate layers are adhesively bonded together by one applied aliquot of hot melt adhesive composition of the invention followed by application of pressure to the substrates/adhesive composition layers during the open time. For example, a first, nonporous substrate such as a plastic film or sheet is provided, onto which a bead of a hot melt adhesive composition of the invention is applied. Then two or more layers of porous substrates such as, for example, a cotton batting, a thermoplastic nonwoven fabric such as a polyolefin or polyester nonwoven fabric, and/or a woven fabric such as a cotton or cotton/polyester blend woven fabric, are placed on top of the first substrate and pressure is applied, for example by a roller, to cause all the substrates to become adhesively affixed. Adhesion of multiple layers in this manner is possible because the adhesive can be extruded directly onto a substrate.

In embodiments where spray application is employed, the hot melt adhesive compositions of the invention reach ambient temperatures upon immediate contact with the adherend. This is because the spray-on adhesive takes on the form of fibers that have substantial surface area in comparison to the mass of the fiber. Sprayed adhesives take the form of a solid matrix formed as a result of the combined adhesive fibers creating an overlapping distribution of threads or fibers on a substrate. In some embodiments, ambient temperature of the packaging adhesive application is between about 10° C. to 40° C. It is a substantial advantage of the hot melt adhesive compositions of the invention that in all such applications, the effective set time of the adhesive is less than 5 seconds, and in many embodiments is about 0.1 to 2 seconds.

The amount of the hot melt adhesive composition of the invention that is applied between two or more substrates in order to achieve satisfactory adhesive bonding will vary depending on both the particular composition as well as the challenges expected in the particular application, as will be appreciated by one of skill. In many embodiments, the hot melt adhesive compositions of the invention are applied by a machine spraying a cylindrical bead of adhesive onto a first substrate, wherein the first substrate is defined as the substrate upon which the adhesive is applied in molten form. The cylinder flattens out upon contact with the first substrate and flattens further upon contact with a second substrate. In such embodiments, the cross sectional area of the adhesive bead as applied by the nozzle is determined by the diameter of the bead of hot melt adhesive composition as it leaves the nozzle. In embodiments, the diameter of the bead of hot melt adhesive composition applied to a first substrate is about 0.5 millimeters to 1 centimeter, or about 1.0 millimeters to 6.5 millimeters, or about 1.5 millimeters to 4 millimeters. The length of the bead applied to the substrate depends on the size of the substrate and the length of the bond required between the first and second substrates. The length of the bead will vary depending on the application and the size and type of substrates being employed. Thus, in an illustrative example, where a 1 centimeter long bead is applied to the first substrate, the volume of hot melt adhesive composition applied is 4.4 mm³ in the case of an 0.75 millimeter cylindrical bead diameter or 3.1 cm³ in the case of a 1 centimeter cylindrical bead diameter. In another illustrative example, manufacturing of cellular blind assemblies often involves assembly lengths of up to about 244 cm; in such an embodiment, the volume of hot melt adhesive composition applied is about 479 mm³ in the case of an 0.5 mm cylindrical bead diameter and about 192 cm³ (1.92×10⁵ mm³) in the case of a 1 cm cylindrical bead diameter.

Here, the advantage of the relatively low density of the adhesive composition compared to conventional hot melt adhesives employed in cellular blind assemblies is evident. Where the density of the composition employed is 0.9 g/cm³, the weight of an adhesive bead having a volume of 479 mm³ is 0.431 g, and the weight of an adhesive bead having a volume of 192 cm³ is 173 g. The same volumes of conventional adhesives having a density of 1.2 g/cm³, such as many conventional copolyester-based hot melt adhesives, have weights that are 25% lower: 0.575 g and 230 g, respectively. When the weight difference is multiplied over 1 to 1000 cells adhered together in a stacked assembly, the weight difference is even more significant. A substantial advantage in terms of the lowered total weight of the blind, and in the cost of assembly, is realized. The differences in density of the hot melt adhesives employed in the cellular blind assemblies of the invention, compared to conventional hot melt adhesive formulations, are only illustrated in the above example. Some conventional hot melt adhesives have a density greater than 1.2 g/cm³, whereas some of the hot melt adhesive compositions employed in the cellular blind assemblies of the invention are less than 0.9 g/cm³.

Once two or more substrates are contacted with a hot melt adhesive composition disposed between them, the composition must build both adhesion to each substrate as well as cohesive strength in order to secure the substrates with an adhesive bond. Thus, the rate of formation of these properties is critical in a hot melt adhesive application. The rate of crystallization of the semicrystalline propylene polymer controls the rate at which the hot melt adhesive compositions build cohesive strength.

### EXPERIMENTAL SECTION

### Examples 1-2

Two hot melt adhesive compositions were formulated using the materials and amounts indicated in Table 1. The compositions were labeled Example 1 and Example 2 (Ex. 1 and Ex. 2).

TABLE 1
Components of Ex. 1 and Ex. 2 compositions.

| | | Wt. Percent | |
|---|---|---|---|
| Material | Supplier | Ex. 1 | Ex. 2 |
| VISTAMAXX ® 8816 | ExxonMobil Chemical, | 69 | 66 |
| | Houston, TX | | |
| IRGANOX ® 1010 | Ciba Geigy Ltd., Basel, | 0.5 | 0.5 |
| | Switzerland | | |
| BLS-1328 | Mayzo Inc., Suwanee, GA | 0.25 | 0.25 |
| BLS-1770 | Mayzo Inc., Suwanee, GA | 0.25 | 0.25 |
| VISTAMAXX ® 2330 | ExxonMobil Chemical, | 25 | 25 |
| | Houston, TX | | |
| A-C ® 596 | Honeywell Intl. Inc., | 5 | 5 |
| | Morristown, NJ | | |
| POLYWAX ® 3000 | Baker Hughes Inc., | 0 | 3 |
| | Sugar Land, TX | | |

To form the compositions, all of the components except VISTAMAXX® 2330 were heated at 177° C. (350° F.) until melted. Mechanical mixing was started at a moderate rate of speed while the VISTAMAXX® 2330 was slowly added until dissolved and the sample appeared homogeneous.

A portion of each composition was removed for analysis upon completion of mixing. Each composition was analyzed for Brookfield Thermosel Viscosity (spindle SC4-27); an average of 4900 cP at 177° C. was measured for Ex. 1, and an average of 4550 cP at 177° C. was measured for Ex. 2. The ring-and-ball softening point was also measured for each composition and was found to average about 160° C. (320° F.) for both Ex. 1 and Ex. 2.

The Shear Adhesion Fail Temperature (SAFT) and Peel Adhesion Fail Temperature (PAFT) for Ex. 1 was measured according to ASTM-D4498, wherein the test protocol was modified as follows. Each sample was coated onto kraft paper by hand using glass rods or shims. The resultant coatings were one inch (2.5 cm) wide bands about 8-10 mils (about 0.2-0.25 mm) or about 0.008 to about 0.010 inches (about 0.02 to about 0.03 cm) thick. Four to five such bonds were made for the peel (PAFT) test and four to five bonds were made for the shear (SAFT) test and the results were averaged. The samples were placed in a programmed oven after attaching 100 g weights for PAFT and 500 g weights for SAFT, and ramping the temperature at 25° C./hour, starting at 25° C. The oven automatically recorded the temperature at which the samples failed.

Using the described test protocol, the average SAFT for Ex. 1 was 129° C. (265° F.) and the average PAFT for Ex. 1 was 72° C. (162° F.).

Specific gravity of each composition was measured and found to be 0.89 g/cm² for both Ex. 1 and Ex. 2.

Two curable copolyester-based hot melt adhesives were obtained from Bostik, Inc. of Wauwatosa, Wis.: Bostik Vitel 4365 (Control 1) and Bostik VW4360BP-1C (Control 2). The reported values for the Bostik adhesives are as follows. Brookfield Thermosel Viscosity of Control 1: 7800 cP at 200° C. (392° F.) and 4500 cP at 215° C. (419° F.); ring-and-ball softening point: 132°-142° C. (270°-288° F.); specific gravity:1.28 g/cm². Brookfield Thermosel Viscosity of Control 2: 5500 cP at 215° C. (419° F.) and 3000 cP at 238° C. (460° F.); ring-and-ball softening point: 132°-142° C. (270°-288° F.); specific gravity: 1.28 g/cm².

### Example 3

Samples of Ex. 1 and Ex. 2 as well as Controls 1 and 2 are used to form blinds having a construction similar to that shown in FIG. 2B, where each formulation is delivered as hot melt adhesive beads substantially as described herein.

A white polyester nonwoven fabric having a basis weight of 64.3 g/m² is cut into strips 5.1 cm wide and 1 meter long, such that the strip is represented by the substrate shown in FIGS. 1A and 1B. An adhesive bead 130 is applied over the entirety of length 102 near edge 108 on surface 110 of each strip, as shown in FIG. 1A. The adhesive bead 130 is substantially cylindrical and has a diameter of about 2 mm. The adhesive is applied using a standard hot melt adhesive apparatus with a nozzle dispenser, operated in continuous fashion and traversing the entirety of the length 102 of the substrate of FIG. 1A at a rate of about 1 meter per second. Ex.s 1 and 2 are applied at 177° C. (350° F.). Control 1 is applied at 215° C. (419° F.). Control 2 is applied at 238° C. (460° F.). As the bead is applied, the strip is folded and compressed using a heated roller apparatus, such that the edge 106 is contacted with adhesive bead 130 within about 1 second of adhesive bead application to edge 108, to form a cellular element 100 as shown in FIG. 1D. During the compression, a crease 140 as shown in FIG. 1D is also formed.

All adhesive bonds are observed to be stable immediately upon completing the above procedure. Each cellular element, once formed, is immediately pulled apart by hand. In each case, failure occurs within the fabric itself—that is, the fabric is ripped apart, and the bond remains firmly in place.

The bonded areas of the cellular elements are inspected by cutting into a cellular element to observe the extent of penetration of the adhesive into the polyester nonwoven. For Ex.s 1 and 2, it is observed that the adhesive appears to penetrate some portion of the thickness of the nonwoven. The element assembled using the composition Ex. 1 shows a slight amount of bleed through of the adhesive to the outer surface of the element. The fabric outer surfaces of the bonded area formed using Ex. 2 shows no bleed through of the adhesive to the outer surface of the polyester nonwoven fabric. For the Controls, it is observed that the adhesive does not appear to penetrate any portion of the thickness of the nonwoven, nor is there any bleed through of the Control adhesives.

The cellular elements are weighed after bond formation. The basis weight of the polyester nonwoven is 64.3 g/m². The cellular elements formed using Ex. 1 and Ex. 2 on a nonwoven strip 5.1 cm wide and 1 meter long weigh 14.4 g. The cellular elements formed using Control 1 and Control 2 on a 5.1 cm wide and 1 meter long strip weigh 19.3 g. Thus, single cellular blind elements formed using adhesive compositions Ex. 1 and Ex. 2 weigh about 25% less than the elements formed using the Control adhesives.

### Example 4

Ex. 1, Ex. 2, Control 1, and Control 2 are used to form blind assemblies 201 similar to that shown in FIG. 2B. First, fifty cellular elements 100 as shown in FIG. 1D are formed for each of Ex. 1, Ex. 2, Control 1, and Control 2, using the procedure of Example 3. Each group of fifty elements is used to form an assembly 201 of FIG. 2B.

To construct a blind assembly 201 of FIG. 2B, a first element 100 is maintained in a flattened configuration, along crease 240 as provided in Example 2 after applying the heated roller apparatus. Then an adhesive bead 230 is applied over the length 102 on surface 120 of each strip, as shown in FIG. 1D and FIG. 2B, except that the element is in a flattened configuration and not the expanded configuration shown in FIG. 1D and FIG. 2B. The adhesive bead 130 is the same adhesive as applied in formation of the cellular element 100. The adhesive bead is substantially cylindrical and has a diameter of about 2 mm. The adhesive bead is applied lengthwise along the entire length of each element 100, at a point approximately midway between the inner edge of adhesive bead 130 and crease 240. The adhesive is applied using standard hot melt adhesive apparatus with a nozzle dispenser, operated in continuous fashion and traversing the length 102 of the cellular element at a rate of about 1 meter per second. Ex.s 1 and 2 are applied at 177° C. (350° F.). Control 1 is applied at 215° C. (419° F.). Control 2 is applied at 238° C. (460° F.). As the bead is applied, another cellular element 100 is stacked on top of the first cellular element 100 and the stack is compressed using a roller apparatus, such that adhesive bead 230 is contacted with two cellular elements within about 1 second of adhesive bead application. This step is then repeated with the remaining forty-eight elements 100, to result in a blind assembly 201 having 25 cellular elements 100.

Each assembly thus has fifty strips of polyester nonwoven material, wherein each strip is 5.1 cm wide and 1 meter long; and ninety-nine beads of adhesive. The assemblies formed using Ex. 1 and 2 compositions weigh about 1.27 kg, whereas the assemblies formed using the Control 1 and 2 adhesives weigh about 1.75 kg.

Each assembly is cut into sections 2.54 cm (1 inch) wide, wherein each 2.54 cm section includes all 50 cellular elements. The tensile strength of the assembly is measured using a Centor First digital force gauge (obtained from Com-Ten Industries of Pinellas Park, Fla.) mounted on a motorized test stand and fitted with one long-arm hook attached to the gauge and another long-arm hook fitted to the movable base of the motorized stand. The long-arm hooks have long horizontal sections, whereby the 2.54 cm assembly width is able to be hooked without any bunching of the fabric during the test. The base is raised until the long-arm hooks are about 2.54 cm (1 inch) apart. The hooks are threaded through two randomly selected contiguous elements of the assembly. The gauge is zeroed, then the motorized stand is set to move the base downward at a rate of 2.54 cm (1 inch) per minute. The motorized stand is connected to the gauge in a manner that causes the motor to stop moving the base downward upon failure of the sample. The peak force on the gauge is measured, and the sample observed for mode of failure. The test is repeated at least three times for each assembly.

Using this technique, it is observed that in each case, the assemblies fail by ripping of the fabric rather than by adhesive or cohesive failure of the adhesive bonds.

### Example 5

A 2.54 cm wide section of each of the four assemblies formed in Example 3 are suspended from long-arm hooks situated on the ceiling of an oven, wherein the sections hang freely inside the oven and do not touch the oven floor. The oven temperature is pre-set to 71° C. (160° F.) and the assemblies are allowed to remain suspended in the heated oven for three hours. At the end of the three hours, all the assemblies are intact.

### Example 6

A 2.54 cm wide section of the assemblies formed in Example 3 and including compositions Ex. 1 and Ex. 2 are cut and mounted inside UV test chamber, wherein the section is inserted into grips to hold the section in a fully expanded conformation such that the edge of the adhesive beads holding the elements together is visible. The sections are exposed to UV radiation intended to mimic sunlight, wherein the UV bulbs are situated perpendicular to the direction of expansion of the sections. The sections are exposed to UV light for 96 continuous hours, then they are removed and subjected to tensile testing as described in Example 4. The result for Ex. 1 and Ex. 2 are unchanged compared to the results of Example 4.

The present invention may suitably comprise, consist of, or consist essentially of, any of the disclosed or recited elements. The invention illustratively disclosed herein can be suitably practiced in the absence of any element which is not specifically disclosed herein. The various embodiments described above are provided by way of illustration only and should not be construed to limit the claims attached hereto. It will be recognized that various modifications and changes may be made without following the example embodiments and applications illustrated and described herein, and without departing from the true spirit and scope of the following claims.

We claim:

1. A cellular blind construction comprising
a. a plurality of cellular elements, each element having an outer surface and a length, the outer surface including a first element contact area and a second element contact area, the element contact areas spanning length of the cellular elements; and
b. an effective amount of a hot melt adhesive composition disposed between the cellular elements to adhere the elements to each other at their respective first and second element contact areas, the hot melt adhesive composition comprising:
i. a copolymer of propylene and at least one comonomer selected from the group consisting of ethylene and C₄ to C₂₀ α-olefins, wherein the copolymer has a propylene content of greater than 65 mole %, a Brookfield viscosity at 190° C. of about 200 cP to 25,000 cP, and a density of about 0.860 g/cm³ to 0.868 g/cm³; and
ii. about 0.1 wt % to 10 wt % of a functionalized polyolefin comprising groups derived from maleic anhydride or acrylic acid.

2. The cellular blind construction of claim 1 wherein the cellular elements individually comprise
a. a substrate having a length, a width, a first lengthwise edge, a second lengthwise edge, and a first major surface comprising a first contact area and a second contact area, and a second major surface, wherein the first contact area spans the length proximal to the first lengthwise edge and the second contact area spans the length proximal to the second lengthwise edge; and
b. an effective amount of a hot melt adhesive composition disposed between the first and second contact areas and adhering the first and second contact areas, the hot melt adhesive composition comprising
i. a copolymer of propylene and at least one comonomer selected from the group consisting of ethylene and C₄ to C₂₀ α-olefins, wherein the copolymer has a propylene content of greater than 65 mole %, a Brookfield viscosity at 190° C. of about 200 cP to 25,000 cP, and a density of about 0.860 g/cm³ to 0.868 g/cm³; and
ii. about 0.1 wt % to 10 wt % of a functionalized polyolefin comprising groups derived from maleic anhydride or acrylic acid;
wherein the width of the substrate between the first and second contact areas defines the diameter of the cellular element, the length of the substrate defines the length of the cellular element, and the second major surface of the substrate defines the outer surface of the cellular element; and wherein the adhesive composition disposed between the first and second contact areas is the same or different from the adhesive composition disposed between the cellular elements.

3. The cellular blind construction of claim 1 wherein the cellular elements comprise a knit fabric, a woven fabric, a nonwoven fabric, a foam, a foil, a sheet, or a combination of one or more thereof.

4. The cellular blind construction of claim 2 wherein the substrate comprises a knit fabric, a woven fabric, or a nonwoven fabric, or a combination of one or more thereof.

5. The cellular blind construction of claim 3 wherein the fabric comprises a nylon, a polyester, or a combination of one or more thereof.

6. The cellular blind construction of claim 3 wherein the sheet comprises a fiberglass, a polyester, aluminum, wood, or a combination of one or more thereof.

7. The cellular blind construction of claim 4 wherein the substrate comprises a nonwoven polyester fabric.

8. The cellular blind construction of claim 1 wherein the adhesive composition comprises a copolymer having a propylene content of about 80 mole % to 99.9 mole %.

9. The cellular blind construction of claim 2 wherein the adhesive composition disposed between the first and second contact areas comprises a copolymer having a propylene content of about 80 mole % to 99.9 mole %.

10. The cellular blind construction of claim 1 wherein the adhesive composition comprises a copolymer wherein the comonomer is ethylene, 1-hexene, or a combination thereof.

11. The cellular blind construction of claim 2 wherein adhesive composition disposed between the first and second contact areas comprises a copolymer wherein the comonomer is ethylene, 1-hexene, or a combination thereof.

12. The cellular blind construction of claim 1 wherein the adhesive composition comprises about 50 wt % to 99.5 wt % of the propylene copolymer.

13. The cellular blind construction of claim 2 wherein the adhesive composition disposed between the first and second contact areas comprises about 50 wt % to 99.5 wt % of the propylene copolymer.

14. The cellular blind construction of claim 1 wherein the copolymer of propylene comprises a blend of two copolymers having different molecular weights.

15. The cellular blind construction of claim 2 wherein the adhesive composition disposed between the first and second contact areas comprises copolymer of propylene comprises a blend of two copolymers having different molecular weights.

16. The cellular blind construction of claim 1 wherein the adhesive composition comprises about 1 wt % to 10 wt % of a nucleating agent.

17. The cellular blind construction of claim 2 wherein the adhesive composition disposed between the first and second contact areas comprises about 1 wt % to 10 wt % of a nucleating agent.

18. The cellular blind construction of claim 1 wherein the adhesive composition comprises about 0.01 wt % to 5 wt % of one or more hindered amine light stabilizers.

19. The cellular blind construction of claim 2 wherein the adhesive composition disposed between the first and second contact areas comprises about 0.01 wt % to 5 wt % of one or more hindered amine light stabilizers.

20. The cellular blind construction of claim 1 wherein the adhesive further comprises about 0.01 wt % to 5 wt % of one or more hindered phenol compounds.

21. The cellular blind construction of claim 2 wherein the adhesive composition disposed between the first and second contact areas further comprises about 0.01 wt % to 5 wt % of one or more hindered phenol compounds.

22. The cellular blind construction of claim 1 wherein the adhesive composition has a set time of about 0.5 second to 10 seconds.

23. The cellular blind construction of claim 2 wherein the adhesive composition disposed between the first and second contact areas has a set time of about 0.5 second to 10 seconds.

24. The cellular blind construction of claim 1 wherein the adhesive composition has an open time of about 0.5 second to 30 seconds.

25. The cellular blind construction of claim 2 wherein the adhesive composition disposed between the first and second contact areas has an open time of about 0.5 second to 30 seconds.

26. The cellular blind of claim 1, wherein the blind is a pleated blind.

27. A double-cell blind construction comprising
a. a pleated substrate attached between pleats in a double-cell configuration, and
b. a hot melt adhesive composition disposed between the pleats to attach the pleats in the double-cell configuration, the hot melt adhesive composition comprising:
i. a copolymer of propylene and at least one comonomer selected from the group consisting of ethylene and C₄ to C₂₀ α-olefins, wherein the copolymer has a propylene content of greater than 65 mole %, a Brookfield viscosity at 190° C. of about 200 cP to 25,000 cP, and a density of about 0.860 g/cm³ to 0.868 g/cm³; and
ii. about 0.1 wt % to 10 wt % of a functionalized polyolefin comprising groups derived from maleic anhydride or acrylic acid.

28. The blind construction of claim 27 wherein the substrate comprises a fabric comprising a knit fabric, a woven fabric, or a nonwoven fabric, or a combination of one or more thereof.

29. The blind element of claim 28 wherein the fabric comprises a nylon, a polyester, or a combination of one or more thereof.

30. The blind construction of claim 27 wherein the adhesive composition comprises a copolymer having a propylene content of about 80 mole % to 99.9 mole %.

31. The blind construction of claim 27 wherein the adhesive composition comprises a copolymer wherein the comonomer is ethylene, 1-hexene, or a combination thereof.

32. The blind construction of claim 27 wherein the adhesive composition comprises about 50 wt % to 99.5 wt % of the propylene copolymer.

33. The blind construction of claim 27 wherein the copolymer of propylene comprises a blend of two copolymers having different molecular weights.

34. The blind construction of claim 27 wherein the adhesive composition comprises about 1 wt % to 10 wt % of a nucleating agent.

35. The blind construction of claim 27 wherein the adhesive composition comprises about 0.01 wt % to 5 wt % of one or more hindered amine light stabilizers.

36. The blind construction of claim 27, the adhesive further comprising about 0.01 wt % to 5 wt % of one or more hindered phenol compounds.

37. The blind construction of claim 27 wherein the adhesive has a set time of about 0.5 second to 10 seconds.

38. The blind construction of claim 27 wherein the adhesive has an open time of about 0.5 second to 30 seconds.

39. A method of making a cellular blind assembly, the method comprising the steps of
a) applying a first effective amount of a molten hot melt adhesive composition to a first contact area of a first major surface of a substrate, the hot melt adhesive composition comprising
i. at least one polypropylene copolymer having one or more comonomers selected from the group including ethylene and a C₄ to C₂₀ α-olefin, and
ii. at least one functionalized polyolefin comprising groups derived from maleic anhydride or acrylic acid;
b) contacting the first element contact area to a second element contact area to form a first cellular blind element;
c) applying a second effective amount of the molten hot melt adhesive composition to a first element contact area of the first cellular blind element;
d) contacting the first element contact area of the first cellular element to a second contact area of a second cellular element; and
e) repeating steps a) to d) from 1 to 1000 times to form a cellular blind assembly.

40. The method of claim 39, further comprising pleating the substrate.

41. The method of claim 39 wherein each of steps a. and b. are carried out contemporaneously with steps c. and d.

42. The method of claim 39 wherein step b. is carried out within about 0.1 seconds to 3 seconds after completing step a. and wherein step d. is carried out within 0.1 second to 3 seconds after completing step c.

43. The method of claim 39 wherein the viscosity of the molten hot melt adhesive composition is about 300 cP to 5000 cP at 180° C. when measured according to ASTM D3236.

44. The method of claim 39 wherein the method further comprises attaching one or more bottom rails, top panels, lift cords, fabric tapes, decorative items, or combination thereof to the cellular blind assembly.

45. The method of claim 44 wherein the one or more bottom rails, top panels, lift cords, fabric tapes, decorative items, or combination thereof are attached to the cellular blind assembly using the hot melt adhesive composition.

46. A method of making a double-cell blind assembly, the method comprising the steps of
a) applying a first effective amount of a molten hot melt adhesive composition to a first contact area of a first major surface of a substrate, the hot melt adhesive composition including
i. at least one polypropylene copolymer having one or more comonomers selected from the group including ethylene and a C₄ to C₂₀ α-olefin, and
ii. at least one functionalized polyolefin comprising groups derived from maleic anhydride or acrylic acid;
b) contacting the first contact area to a second contact area of the first major surface of the substrate to form a first cellular blind element;
c) applying a second effective amount of the molten hot melt adhesive composition to a third contact area of a second major surface of the substrate;
d) contacting the third contact area to a fourth contact area on the second major surface to form a second cellular blind element; and
e) repeating steps a) to d) from 1 to 1000 times to form a double-cell blind assembly.

47. The method of claim 4 wherein each of steps a. and b. are carried out contemporaneously with steps c. and d.

48. The method of claim 46 wherein step b. is carried out within about 0.1 seconds to 3 seconds after completing step a. and step d. is carried out within 0.1 second to 3 seconds after completing step c.

49. The method of claim 46 wherein the viscosity of the molten hot melt adhesive composition is about 300 cP to 5000 cP at 180° C. when measured according to ASTM D3236.

50. The method of claim 46 wherein the method further comprises attaching one or more bottom rails, top panels, lift cords, fabric tapes, decorative items, or combination thereof to the cellular blind assembly.

51. The method of claim 50 wherein the one or more bottom rails, top panels, lift cords, fabric tapes, decorative items, or combination thereof are attached to the cellular blind assembly using the hot melt adhesive composition.
